(19) United States
(12) Patent Application Publication
(10) Pub. No.: US 2012/0261405 A1
(43) Pub. Date: Oct. 18, 2012

(54) INDUCTION HEATING APPARATUS AND INDUCTION HEATING COOKER PROVIDED WITH SAME

(75) Inventors: Yoichi Kurose, Kyoto (JP); Takeshi Kitaizumi, Kyoto (JP); Naoaki Ishimaru, Shiga (JP)

(73) Assignee: PANASONIC CORPORATION, Kadoma-shi, Osaka (JP)

(21) Appl. No.: 13/514,566

(22) PCT Filed: Dec. 9, 2010
(86) PCT No.: PCT/JP10/07162

§ 371 Date: Jun. 7, 2012

(30) Foreign Application Priority Data
Dec. 11, 2009 (JP) 2009-281279
Jun. 30, 2010 (JP) 2010-148733

(51) Int. Cl. H05B 6/04; H05B 6/12

(52) U.S. Cl. 219/620; 219/671

(57) ABSTRACT

An induction heating apparatus according to the present invention includes: an inverter circuit which outputs an AC signal through ON and OFF operations of a plurality of switching devices; a control portion which drives and controls the plurality of switching devices; and a plurality of resonant circuits which includes respective resonant capacitors and respective heating coils for inductively heating an object to be heated; wherein the switching devices are driven and controlled, by using, as an operating range, a frequency range higher than a highest resonance frequency, or a frequency range lower than lowest resonance frequency, out of respective resonance frequencies of the plurality of resonant circuits, and the respective heating coils in the plurality of resonant circuits are combined to form at least a single induction heating source.

### TECHNICAL FIELD

The present invention relates to induction heating apparatuses for inductively heating objects to be heated using heating coils and, more particularly, relates to induction heating apparatuses for inductively heating pans made of metals and the like, as objects to be heated, using a plurality of heating coils, and also relates to induction heating cookers including such induction heating apparatuses.

### BACKGROUND ART

A conventional common induction heating cooker will be described, with reference to the accompanying drawings. FIG. 19A is a cross-sectional view illustrating a conventional induction heating cooker in a state where it is incorporated in a cabinet of a kitchen apparatus. FIG. 19B is a plan view illustrating the conventional induction heating cooker illustrated in FIG. 19A.

As illustrated in FIG. 19A and FIG. 19B, the induction heating cooker includes a cabinet which is constituted by a flat-plate shaped top plate 1 made of a nonmetal such as a heat-resistant glass, and a housing portion 8 provided under the top plate 1. An object to be heated, such as a pan, is placed at a predetermined position (a heating area) on the top plate 1 to be inductively heated.

Inside the housing portion 8, there are placed heating coils 21, 22 and 23 for inductively heating the object to be heated placed on the top plate 1, such that there is interposed a space with a size of about 5 mm, between the heating coils and the back surface of the top plate 1.

The induction heating cooker illustrated in FIG. 19A and FIG. 19B is provided with the three heating coils 21, 22 and 23, such that the left heating coil 21 and the right heating coil 22 are placed in a front side, and the center heating coil 23 is placed in a rear side, midway between the left heating coil 21 and the right heating coil 22. Further, the induction heating cooker illustrated in the plan view of FIG. 19B is adapted such that a user manipulates this induction heating cooker at a lower side in the figure, wherein the aforementioned terms “left”, “right”, “front” and “back” refer to left, right, front and back sides viewed from the user.

Inside the housing portion 8, there is placed a roaster 6 for performing cooking for roasted fish and the like, under the left heating coil 21. The roaster 6 is provided, inside thereof, with an electric-resistance heater, a gridiron, and a receiver plate.

Further, inside the housing portion 8, on the right of the roaster 6, there is provided an inverter circuit 5 for supplying AC electric currents to the three heating coils (the left heating coil 21, the right heating coil 22 and the center heating coil 23). The inverter circuit 5 is structured to include a plurality of inverter circuit boards which are associated with the respective heating coils 21, 22 and 23 and, further, are placed at upper and lower positions (refer to Japanese Patent No. 3613109 (Patent Literature 1), for example).

FIG. 20 and FIG. 21 are plan views illustrating the shapes of the heating coils used in conventional induction heating cookers. Induction heating is heating an object to be heated through magnetic fluxes generated by the electric currents flowed through the heating coils and, therefore, has the problem of the occurrence of heating unevenness when there is significant unbalance of magnetic fluxes.

FIG. 20 illustrates a conventional common heating coil 24 which is constituted by a coil wire continuously wound in a spiral shape at even intervals. The heating coil 24 illustrated in FIG. 20 has lower magnetic flux densities at a center portion (an inner-diameter side area) and outer portions (outer-diameter side areas) of this spiral-shaped heating coil 24 and has higher magnetic flux densities at midway areas between the inner-diameter side areas and the outer-diameter side areas, thereby inducting denseness of magnetic fluxes. To cope therewith, in order to suppress such denseness of magnetic fluxes around the midway areas of heating coils, there have been suggested structures for forming gap portions in midway areas of heating coils (refer to JP-A No. 2005-353458 (Patent Literature 2), for example).

FIG. 21 illustrates a heating coil 25 having a split-winding shape which is provided with a gap portion 26 including no coil wire, in a midway area of the heating coil 25. As illustrated in FIG. 21, since the heating coil 26 has the split-winding shape having the gap portion 26 in its midway area, it is possible to place a temperature sensor 33 for detecting the temperature of the pan as the object to be heated, in the midway area of the heating coil 25 in which the temperature of the pan is raised most.

FIG. 22 is a circuit diagram illustrating the structure of an inverter circuit in a conventional induction heating cooker. Referring to FIG. 22, the inverter circuit is adapted to input an AC electric current to the heating coil 30 for supplying electric power thereto, so that the object to be heated 34 placed on the top plate generates eddy currents to generate heat therefrom.

The inverter circuit is adapted to convert a direct current into a high-frequency alternating current through ON and OFF operations of two switching devices 31 and 32 and to supply it to the resonant circuit including the heating coil 30. The inverter circuit illustrated in FIG. 22 has a circuit structure for flowing a high-frequency AC electric current through the heating coil 30, which is a circuit structure of a common inverter circuit employed in a conventional induction heating cooker.

Further, some conventional induction heating apparatuses are structured to include a plurality of heating areas and to inductively heat objects to be heated placed in the respective heating areas, through heating coils placed under the respective heating areas (refer to Japanese Patent No. 2722738 (Patent Literature 3), for example). The conventional induction heating apparatus disclosed in Patent Literature 3 includes a plurality of resonant circuits including heating coils, wherein a single inverter circuit is connected to the plurality of resonant circuits. In the conventional induction heating apparatus disclosed in Patent Literature 3, the respective resonant circuits have different resonance frequencies and are adapted to be driven by changing over among the plurality of heating coils. Further, this conventional induction heating apparatus is adapted to control the ratio between the heating electric powers from the respective heating coils, through the operating frequency of the inverter circuit.
Patent Literature 1: Japanese Patent No. 3613109
Patent Literature 2: Japanese Unexamined Patent Publication No. 2005-353458
Patent Literature 3: Japanese Patent No. 2722738

### SUMMARY OF THE INVENTION

### Technical Problem

As described above, since the conventional induction heating apparatus disclosed in Patent Literature 3 is adapted to control the ratio between the heating electric powers from the respective heating coils, through the operating frequency of the single inverter circuit, this induction heating apparatus has the problem that the operating frequency of the inverter circuit cannot be arbitrary changed.

FIG. 23 is a view illustrating frequency characteristics of the heating voltages from two heating coils (a first heating coil and a second heating coil), when different voltages (70 V, 85 V, 100 V) are inputted to the inverter circuit, in the conventional induction heating apparatus disclosed in Patent Literature 3. FIG. 23 illustrates the fact that the heating output from the first heating coil is 1000 W, and the heating output from the second heating coil is 600 W, when a DC voltage of 85 V is inputted to the inverter circuit, and the inverter circuit is operated at a frequency of 26 kHz. Further, as illustrated in FIG. 23, the two resonant circuits including the respective heating coils have different resonance frequencies, wherein the resonant circuit including the first heating coil has a resonance frequency of 25 kHz, and the resonant circuit including the second heating coil has a resonance frequency of 28 kHz.

In FIG. 23, there are illustrated two operating points (A, B) indicating states where the inverter circuit is operated at a frequency of 26 kHz, between 25 kHz and 28 kHz which are the resonance frequencies of the two resonant circuits. Due to the operating frequency of 26 kHz, the ratio between the heating electric powers from the first heating coil and the second heating coil is set to 1000 W:600 W, namely 5:3.

In the conventional induction heating apparatus having the frequency characteristics illustrated in FIG. 23, even by continuously changing the operating frequency of the inverter circuit among frequencies between the resonance frequencies of the two resonant circuits, in order to adjust the heating electric powers from the two heating coils, it is difficult to adjust the heating electric powers. For example, if the operating frequency of the inverter circuit is gradually increased, the heating electric power from the first heating coil is gradually decreased, but the heating electric power from the second heating coil is gradually increased. Therefore, the value of the sum of the heating electric powers from the first heating coil and the second heating coil is not simply increased or decreased, which makes it significantly difficult to derive a relation between the operating frequency and the value of the sum of the heating electric powers. Accordingly, with the conventional induction heating apparatus, it has been impossible to adjust the value of the sum of the heating electric powers, by changing the operating frequency of the inverter circuit.

Further, in the frequency characteristics illustrated in FIG. 23, the inverter circuit is operated at a frequency (for example, 26 kHz) which is lower than the resonance frequency (28 kHz) of the resonant circuit including the second heating coil. In the induction heating apparatus, when the heating coils are not magnetically coupled to the object to be heated, the inductances (L) of the heating coils have larger values than those of when they are magnetically coupled thereto.

There is the relationship expressed by the following equation (1), among the resonance frequency f_{LC}, the inductance L of a heating coil, and the capacitance C of a resonant capacitor.

[Equation 1]

f_{LC}=½π√(LC) (1)

Accordingly, as can be clearly seen from the equation (1), the resonance frequency is lower, when there is no magnetic coupling between the second heating coil and the object to be heated.

Accordingly, when there is no magnetic coupling between the second heating coil and the object to be heated, namely when the object to be heated does not exist near the second heating coil, the resonance frequency of the resonant circuit including the second heating coil is set to be around the operating frequency of the inverter circuit.

Further, when there is no magnetic coupling between the second heating coil and the object to be heated, the resonant circuit including the second heating coil has a larger Q factor, and a significantly larger electric current flows through the second heating coil and the inverter circuit. As a result thereof, such conventional induction heating cookers have had the problems of destruction of the switching devices and significant degradation of the heating efficiency due to increased heat generation from the heating coils.

The present invention was made in order to overcome various types of problems in the structures of conventional induction heating cookers and induction heating apparatuses as described above. The present invention aims at providing an induction heating apparatus and an induction heating cooker which are capable of accurately coping with load fluctuations and changes of set electric powers with a higher degree of flexibility in control than those of conventional structures and, also, are capable of reducing leaked electric fields in heating smaller objects to be heated, such as pots, particularly, for offering excellent safety, with reduced manufacturing costs.

### Solution to Problem

An induction heating apparatus in a first aspect of the present invention includes: an inverter circuit including a plurality of switching devices and being adapted to drive the plurality of switching devices for outputting an AC signal; a control portion adapted to drive and control the plurality of switching devices; and a plurality of resonant circuits which are connected, in parallel, to the inverter circuit and include respective resonant capacitors and respective heating coils for inductively heating an object to be heated; wherein the control portion is adapted to drive and control the plurality of switching devices, by using, as an operating range, a frequency range higher or lower than a highest or lowest resonance frequency, out of respective resonance frequencies of the plurality of resonant circuits, and the respective heating coils in the plurality of resonant circuits are combined to form at least a single induction heating source, whereby the object to be heated is inductively heated by the at least a single induction heating source. The induction heating apparatus having the aforementioned structure in the first aspect serves as a reliable apparatus capable of accurately coping with load fluctuations and changes of electric-power settings and, also, enables reduction of the manufacturing cost and realizes higher safety.

In a second aspect of the present invention, in the induction heating apparatus in the first aspect, particularly, the heating coils and the resonant capacitors in the plurality of resonant circuits have inductances and capacitances, respectively, which can be set, such that the object to be heated is inductively heated by all the heating coils forming the single induction heating source, in the operating range of the switching devices. With the induction heating apparatus having the aforementioned structure in the second aspect, it is possible to adjust the electric power by changing the operating frequency of the inverter circuit. Further, it is possible to change the ratio between the electric powers supplied from the plurality of heating coils to a single to-be-heated object, by changing the operating frequency of the inverter circuit. This enables adjustments according to the temperature distribution and the electric power balance required for the object to be heated.

In a third aspect of the present invention, in the induction heating apparatus in the first aspect, particularly, the control portion can be adapted to drive and control the switching devices, by using, as an operating range, only a frequency range higher than the highest resonance frequency, out of the respective resonance frequencies of the plurality of resonant circuits. With the induction heating apparatus having the aforementioned structure in the third aspect, if the operating frequency of the inverter circuit is lowered, this increases all of the electric powers inputted to the plurality of heating coils, thereby increasing the value of the sum of the electric powers inputted to the respective heating coils. Therefore, by changing the operating frequency of the inverter circuit, it is possible to accurately adjust the electric powers inputted to the heating coils. Further, if any of the heating coils are not magnetically coupled to the object to be heated, reduced electric power is supplied to this heating coil, since this heating coil has a resonance frequency deviated from the operating frequency of the inverter circuit. This prevents destruction of the inverter circuit due to excessive electric currents flowed through the inverter circuit. Further, it is possible to perform switching operations within time intervals during which positive electric currents flow through the switching devices, which enables mildly changing the voltages applied to the switching devices at the time of transitions of the switching devices from a conduction state to a non-conduction state, thereby reducing losses due to the switching operations.

In a fourth aspect of the present invention, in the induction heating apparatus in the third aspect, particularly, a snubber circuit can be connected, in parallel, to the resonant circuits. With the induction heating apparatus having the aforementioned structure in the fourth aspect, it is possible to reduce switching losses induced by the switching operations of the switching devices, thereby further improving the heating efficiency.

In a fifth aspect of the present invention, in the induction heating apparatus in the first aspect, particularly, the control portion can be adapted to drive and control the switching devices, by using, as an operating range, only a frequency range lower than the lowest resonance frequency, out of the respective resonance frequencies of the plurality of resonant circuits. With the induction heating apparatus having the aforementioned structure in the fifth aspect, it is possible to accurately adjust the electric power, by changing the operating frequency of the inverter circuit. Further, it is possible to change the ratio between the electric powers supplied from the plurality of heating coils to an object to be heated, by changing the operating frequency. This enables easily and certainly adjusting it to be a value adaptable to the temperature distribution and the electric power balance required for the object to be heated.

In a sixth aspect of the present invention, in the induction heating apparatus in the fifth aspect, particularly, an inductor can be connected, in series, to the plurality of switching devices, whereby the plurality of switching devices can be caused to perform a soft switching operation such that a phase of an electric current leads a phase of a voltage. With the induction heating apparatus having the aforementioned structure in the sixth aspect, it is possible to accurately adjust the electric power, by changing the operating frequency of the inverter circuit.

In a seventh aspect of the present invention, in the induction heating apparatus in the fifth aspect, particularly, the respective resonance frequencies of the plurality of resonant circuits can be set to have different values, through the inductances of the heating coils and the capacitances of the resonant capacitors. With the induction heating apparatus having the aforementioned structure in the seventh aspect, it is possible to change the ratio between the electric powers supplied from the plurality of heating coils to an object to be heated at a constant operating frequency, regardless of the Q factors of the resonant circuits, thereby causing it to be adaptable to the temperature distribution and the electric power balance required for the object to be heated. Further, it is also possible to adjust the electric powers supplied to the respective heating coils, according to the temperatures of the respective heating coils and the temperature of the object to be heated.

In an eighth aspect of the present invention, in the induction heating apparatus in the seventh aspect, particularly, in the plurality of resonant circuits, the resonance frequency of the resonant circuit including the heating coil to which larger electric power is inputted can be set to be higher than the resonance frequency of the resonant circuit including the heating coil to which smaller electric power is inputted. With the induction heating apparatus having the aforementioned structure in the eighth aspect, the inverter circuit can be operated in a frequency range closer to the resonance frequency of the heating coil to which larger electric power is inputted, which can smoothen the inputting of electric power to the heating coil to which the larger electric power is inputted, thereby enabling heating with excellent efficiency.

In a ninth aspect of the present invention, in the induction heating apparatus in any of the first to eighth aspects, particularly, the ratio between electric powers inputted to the plurality of heating coils forming a single induction heating source can be a ratio coincident with respective areas of the plurality of heating coils which are faced to the object to be heated. With the induction heating apparatus having the aforementioned structure in the ninth aspect, it is possible to reduce the difference in electric-power supply rate per unit area between the electric powers supplied from the plurality of heating coils to the object to be heated, thereby enabling uniformly heating the object to be heated.

In a tenth aspect of the present invention, in the induction heating apparatus in any of the first to eighth aspects, particularly, the ratio between the values of electric currents flowed through the plurality of heating coils forming a single induction heating source can be a ratio coincident with cross-sectional areas of respective coil wires forming the plurality of heating coils which are orthogonal to a direction in which an electric current flows through the coil wires. With the induction heating apparatus having the aforementioned structure in the tenth aspect, since the cross-sectional area of the heating coil through which a smaller electric current flows is made smaller, it is possible to reduce the amount of copper used in the coil wire in the heating coil, thereby reducing the manufacturing cost for the heating coils.

In an eleventh aspect of the present invention, in the induction heating apparatus in any of the first to tenth aspects, particularly, the plurality of heating coils forming a single induction heating source can be placed in the same plane. With the induction heating apparatus having the aforementioned structure in the eleventh aspect, it is possible to uniformly heat the object to be heated placed in the heating area. Further, it is possible to increase the proportion of the electric power supplied to the heating coil being faced to the object to be heated placed in the heating area, which enables induction heating with higher efficiency, even when the object to be heated is placed such that it is deviated from the center portion of the heating area, for example.

In a twelfth aspect of the present invention, in the induction heating apparatus in the third aspect, particularly, the plurality of heating coils forming a single induction heating source can be placed concentrically and can be formed to have respective coil shapes having different diameters. With the induction heating apparatus having the aforementioned structure in the twelfth aspect, it is possible to realize a structure capable of supplying larger electric power to the heating coil with the smaller diameter which is being magnetically coupled to the object to be heated, while supplying no electric power to the heating coil with the larger diameter which is not magnetically coupled to the object to be heated. This enables induction heating with higher efficiency according to the size of the object to be heated, for coping with objects to be heated having various sizes.

An induction heating cooker in a thirteenth aspect of the present invention includes: a top plate for placing an object to be heated thereon; and the induction heating apparatus according to any one of the first to twelfth aspects, wherein a plurality of heating coils as an induction heating source are placed under the top plate. The induction heating apparatus having the aforementioned structure in the thirteenth aspect serves as a reliable apparatus which is capable of accurately coping with load fluctuations and changes of electric-power settings and, also, enables reduction of the manufacturing cost and realizes higher safety. With the induction heating cooker according to the present invention, it is possible to flow a reduced electric current through the heating coil above which the object to be heated does not exist, thereby reducing the leaked magnetic field therefrom.

In a fourteenth aspect of the present invention, in the induction heating cooker in the thirteenth aspect, particularly, the top plate can have a plurality of heating areas for placing the object to be heated thereon, and the induction heating apparatus can be provided as an induction heating source for at least a single heating area, out of the plurality of heating areas. With the induction heating apparatus having the aforementioned structure in the fourteenth aspect, when a pan is heated in a single heating area, and this pan is smaller than this heating area, it is possible to suppress leaked magnetic fields from this heating area, which can suppress magnetic interference between the heating coils, which can occur during inductively heating an object to be heated in other heating areas. This can suppress the occurrence of interference noise.

### Advantageous Effects of the Invention

According to the present invention, it is possible to provide an induction heating apparatus and an induction heating cooker which have excellent safety and are capable of properly coping with load fluctuations, while enabling reduction of the manufacturing cost.

### BRIEF DESCRIPTION OF THE DRAWINGS

FIG. 1 is a circuit diagram illustrating the structure of an inverter circuit and the like, in an induction heating cooker according to a first embodiment of the present invention.

FIG. 2 is a frequency-characteristics diagram indicating the relation between the operating frequency of the inverter circuit and the maximum electric powers which can be inputted to heating coils, according to the first embodiment.

FIG. 3 is a frequency-characteristics diagram indicating the relation between the operating frequency of the inverter circuit and the maximum electric powers which can be inputted to heating coils, in the induction heating cooker according to a second embodiment of the present invention.

FIG. 4 is a frequency-characteristics diagram indicating the relation between the operating frequency of the inverter circuit and the maximum electric powers which can be inputted to the heating coils, in the induction heating cooker according to the second embodiment of the present invention.

FIG. 5 is a frequency-characteristics diagram indicating the relation between the operating frequency of the inverter circuit and the maximum electric powers which can be inputted to heating coils, in an induction heating cooker according to a third embodiment of the present invention.

FIG. 6 is a frequency-characteristics diagram indicating the relation between the operating frequency of the inverter circuit and the maximum electric powers which can be inputted to the heating coils, in the induction heating cooker according to the third embodiment.

FIG. 7 is a frequency-characteristics diagram indicating the relation between the operating frequency of the inverter circuit and the maximum electric powers which can be inputted to the heating coils, in the induction heating cooker according to the third embodiment.

FIG. 8 is a frequency-characteristics diagram indicating the relation between the operating frequency of the inverter circuit and the maximum electric powers which can be inputted to heating coils, in an induction heating cooker according to a fourth embodiment of the present invention.

FIG. 9 is a plan view illustrating the general shapes of heating coils in an induction heating cooker according to a fifth embodiment of the present invention.

FIG. 10 is a view illustrating the shapes of heating coils and the cross sections of the heating coils, in an induction heating cooker according to a sixth embodiment of the present invention.

FIG. 11 is a view illustrating the waveforms of electric currents flowed through the heating coils in an induction heating apparatus, in the induction heating cooker according to the sixth embodiment.

FIG. 12 is a plan view illustrating heating coils in an induction heating apparatus, in an induction heating cooker according to a seventh embodiment of the present invention.

FIG. 13 is a placement view illustrating the relation among the heating coils in the induction heating apparatus, an object to be heated, and a content of the object to be heated, during a heating operation in the induction heating cooker according to the seventh embodiment of the present invention. FIG. 14 is a circuit diagram illustrating the structure of an inverter circuit and the like, in an induction heating apparatus in an induction heating cooker according to an eighth embodiment of the present invention.

FIG. 15 is a frequency-characteristics diagram indicating the relation between the operating frequency of the inverter circuit and the maximum electric powers which can be inputted to heating coils, in the induction heating apparatus in the induction heating cooker according to the eighth embodiment.

FIG. 16 is a frequency-characteristics diagram indicating the relation between the operating frequency of the inverter circuit and the maximum electric powers which can be inputted to respective heating coils, in an induction heating cooker according to a ninth embodiment of the present invention.

FIG. 17 is a circuit diagram illustrating another structure of an induction heating apparatus in an induction heating cooker according to the present invention.

FIG. 18 is a circuit diagram illustrating yet another structure of an induction heating apparatus in an induction heating cooker according to the present invention.

FIG. 19A is a cross-sectional view illustrating a conventional induction heating cooker in a state where it is incorporated in a cabinet of a kitchen apparatus.

FIG. 19B is a plan view illustrating the conventional induction heating cooker in a state where it is incorporated in the cabinet of the kitchen apparatus.

FIG. 20 is a plan view illustrating the shape of a heating coil used in a conventional induction heating cooker.

FIG. 21 is a plan view illustrating the shape of a heating coil used in a conventional induction heating cooker.

FIG. 22 is a circuit diagram illustrating the structure of an inverter circuit in a conventional induction heating cooker.

FIG. 23 is a view illustrating frequency characteristics of two heating coils, when different voltages are inputted to an inverter circuit, in a conventional induction heating cooker.

### DETAILED DESCRIPTION OF THE PREFERRED EMBODIMENTS

Hereinafter, with reference to the accompanying drawings, there will be described induction heating cookers employing induction heating apparatuses as embodiments of an induction heating apparatus according to the present invention. Further, the induction heating apparatus according to the present invention is not limited to the induction heating apparatuses employed in the induction heating cookers which will be described in the following embodiments and is intended to include induction heating apparatuses structured based on technical concepts equivalent to the technical concepts which will be described in the following embodiments and based on technical common senses in the present technical field.

### First Embodiment

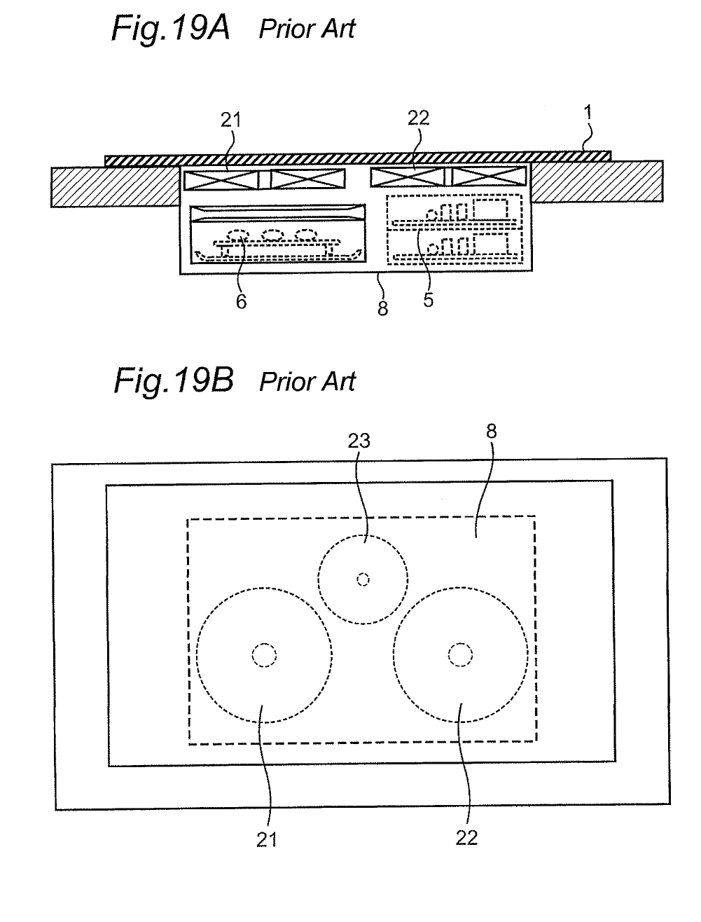

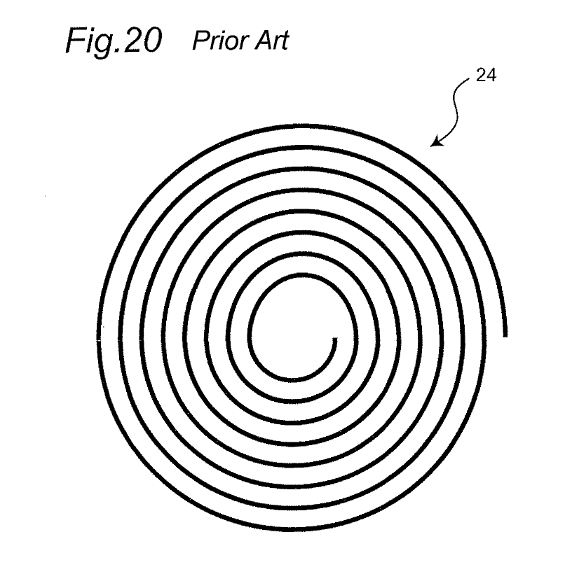

An induction heating cooker according to a first embodiment of the present invention has substantially the same external structure as that of the aforementioned induction heating cooker described with reference to FIGS. 19A and 19B, wherein its external appearance is constituted by a top plate for placing an object to be heated such as a pan thereon, and a housing portion which houses, therein, heating coils, an inverter circuit and the like, which will be described later. The induction heating cooker having the aforementioned structure is used by being incorporated in a cabinet of a kitchen apparatus or the like.

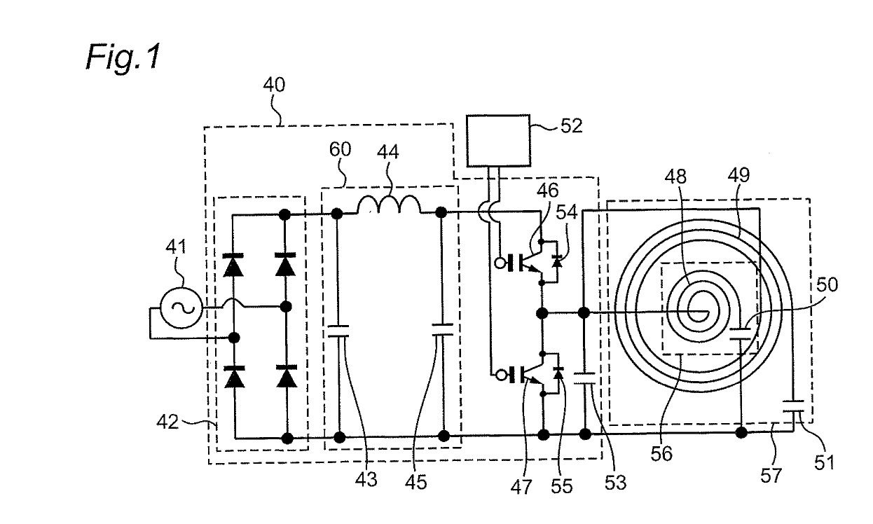

FIG. 1 is a circuit diagram illustrating the structure of the inverter circuit and the like, in an induction heating apparatus, in the induction heating cooker according to the first embodiment of the present invention. As illustrated in FIG. 1, the induction heating apparatus includes the inverter circuit 40 which is supplied with electric power from a commercial power supply 41 constituted by a voltage source, a control portion 52 which drives and controls the inverter circuit 40, and a plurality of resonant circuits 56 and 57 including respective heating coils 48 and 49 and respective resonant capacitors 50 and 51. In FIG. 1, there are illustrated the connections between respective components in the induction heating apparatus.

Further, in the induction heating apparatus according to the first embodiment, the first heating coil 48 and the first resonant capacitor 50 constitute the first resonant circuit 56, while the second heating coil 49 and the second resonant capacitor 51 constitute the second resonant circuit 57.

The induction heating cooker according to the first embodiment is structured to perform induction heating for a single heating area in which an object to be heated is placed, with the two heating coils 48 and 49 having larger and smaller diameters which are different from each other. The object to be heated existing in an inner area in the single heating area is heated by the first heating coil 48 (the heating coil with the smaller diameter), while the object to be heated existing in an outer area is heated by the second heating coil 49 (the heating coil with the larger diameter).

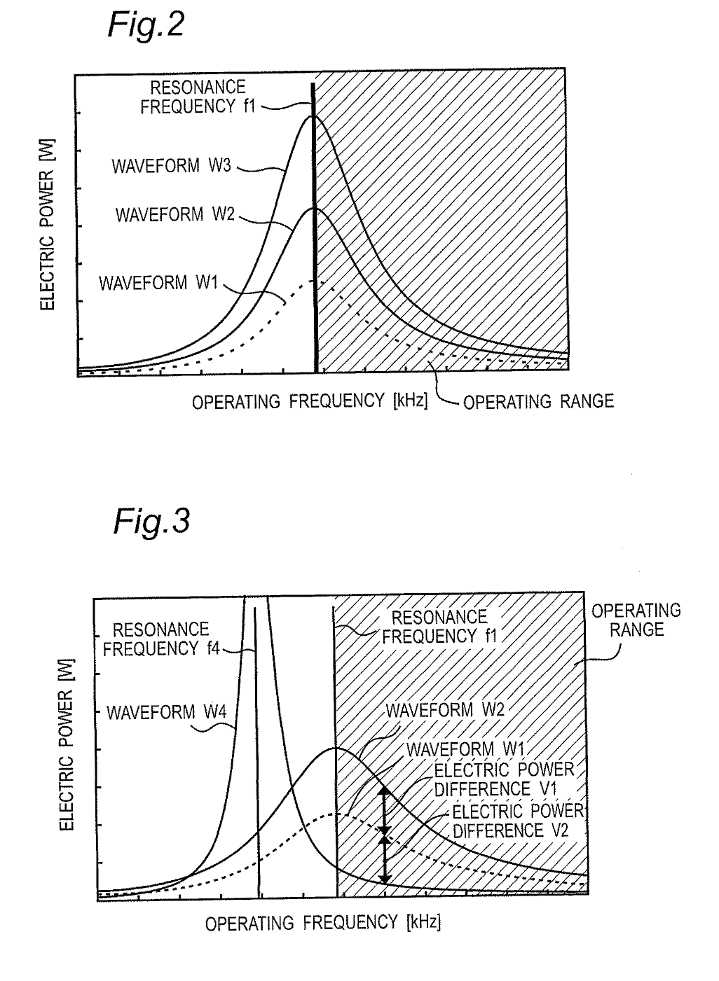

FIG. 2 is a frequency-characteristics diagram indicating the relation between the operating frequency of the inverter circuit 40 and the maximum electric powers which can be inputted to the respective heating coils 48 and 49, in the induction heating apparatus according to the first embodiment of the present invention, wherein the lateral axis represents the operating frequency [kHz], and the longitudinal axis represents the maximum electric power [W] which can be inputted to the heating coils 48 and 49. Referring to FIG. 2, a waveform W1 represents the relation between the operating frequency and the maximum electric power which can be inputted to the first heating coil 48, while a waveform W2 represents the relation between the operating frequency and the maximum electric power which can be inputted to the second heating coil 49. Further, a waveform W3 represents the relation between the operating frequency and the value of the sum of the maximum electric power which can be inputted to the first heating coil 48 and the maximum electric power which can be inputted to the second heating coil 49. The waveform W1 and the waveform W2 indicate frequency characteristics of when an object to be heated is placed in the heating area on the top plate, indicating frequency characteristics in a state where the object to be heated exists above both the first heating coil 48 and the second heating coil 49.

Referring to FIG. 1, the commercial power supply 41 for supplying electric power to the inverter circuit 40 is constituted by an AC power supply and is connected to a diode bridge 42 in the inverter circuit 40, in order to convert the AC power supply into a DC power supply.

In the inverter circuit 40, a filter circuit 60 is connected to output terminals of the diode bridge 42, in order to smoothen the DC power supply resulted from the full-wave rectification, which is outputted from the diode bridge 42, and, also, in order to prevent electromagnetic noise induced by switching operations of the inverter circuit 40 from being transmitted to the commercial power supply 41. The filter circuit 60 is constituted by a first filter capacitor 43, a filter inductor 44, and a second filter capacitor 45. The first filter capacitor 43 and the second filter capacitor 45 are provided in parallel with each other, between a high-potential bus line (hereinafter, referred to as a positive bus line) and a low-potential bus line (hereinafter, referred to as a negative bus line), which form the output terminals of the diode bridge 42. Further, the filter inductor 44 is provided in the high-potential bus line, in such a way as to connect the first filter capacitor 43 and the second filter capacitor 45 to each other.

A first switching device 46 and a second switching device 47 are electrically connected, in series, to the opposite terminals of the second filter capacitor 45 which form output terminals of the filter circuit 60, wherein a first reverse conducting diode 54 is connected in parallel to the first switching device 46, and a second reverse conducting diode 55 is connected in parallel to the second switching device 47.

The first heating coil 48 having the smaller diameter, and the second heating coil 49 having the larger diameter are connected, at their respective one ends, to the point of the connection between the first switching device 46 and the second switching device 47.

The first resonant capacitor 50 is connected, at its one end, to the other end of the first heating coil 48, and the first heating coil 48 and the first resonant capacitor 50 are electrically connected in series to each other. Further, the second resonant capacitor 51 is connected, at its one end, to the other end of the second heating coil 49, and the second heating coil 49 and the second resonant capacitor 51 are electrically connected in series to each other. The first resonant capacitor 50 and the second resonant capacitor 51 are connected, at their respective other ends, to the negative bus line.

In the inverter circuit 40 in the induction heating apparatus according to the first embodiment, a snubber capacitor 53 is electrically connected, in parallel, to the second switching device 47, in order to reduce switching losses induced by the switching operations (ON/OFF operations) of the first switching device 46 and the second switching device 47. The opposite terminals of the snubber capacitor 53, which form output terminals of the inverter circuit 40, are connected to the respective heating coils 48 and 49, with the resonant capacitors 50 and 51 interposed therebetween.

The induction heating apparatus according to the first embodiment is provided with the control portion 52 for driving and controlling the first switching device 46 and the second switching device 47. The control portion 52 is adapted to drive and control the first switching device 46 and the second switching device 47 in such a way as to cause them to exclusively perform ON/OFF operations and, further, is adapted to control the operating frequency and the duty ratio (the ratio between ON and OFF time periods) of the first switching device 46 and the second switching device 47, in order to adjust the electric powers inputted to the first heating coil 48 and the second heating coil 49.

Next, there will be described operations of the induction heating cooker having the aforementioned structure according to the first embodiment.

First, there will be described operations of the inverter circuit 40 according to the first embodiment. In the inverter circuit 40 according to the first embodiment, by changing the operating frequency and the duty ratio of the first switching device 46 and the second switching device 47, it is possible to control the electric power inputted to the first heating coil 48 and the second heating coil 49, namely the electric power supplied to the object to be heated, to be an arbitrary value within a certain range. Here, the operating frequency of the first switching device 46 and the second switching device 47 will be referred to as an operating frequency of the inverter circuit 40, in the following description.

In cases of changing the duty ratio for controlling the electric power inputted to the heating coils 48 and 49, under a condition where the electric potential difference between the positive bus line and the negative bus line is constant, the electric power inputted to the heating coils 48 and 49 is maximized, when the duty ratio is 0.5, namely when the ratio between the ON and OFF time periods of the first switching device 46 and the second switching device 47 is 1:1.

On the contrary, the electric power inputted to the heating coils 48 and 49 is gradually reduced, as the duty ratio is deviated from the value of 0.5 such that it has a value of 0.1 or 0.9, for example.

On the other hand, in cases of changing the operating frequency of the inverter circuit 40 for controlling the electric power inputted to the heating coils 48 and 49, under a condition where the electric potential difference between the positive bus line and the negative bus line is constant, the electric power inputted to the heating coils 48 and 49 is increased, by making the operating frequency of the inverter circuit 40 closer to the resonance frequency f1 of the resonant circuits 56 and 57, as indicated by the frequency characteristics in FIG. 2.

The waveforms of the frequency characteristics illustrated in FIG. 2 are those of when the duty ratio is set to a constant value of 0.5, and maximum electric powers are inputted to the heating coils 48 and 49. Accordingly, by changing the duty ratio, it is possible to input, to the heating coils, electric powers smaller than the electric powers indicated by the waveforms of the frequency characteristics illustrated in FIG. 2.

The waveforms (W1, W2, W3) indicated in FIG. 2 are characteristic curves of when an object to be heated is placed in the heating area which is faced to both the first heating coil 48 and the second heating coil 49. In FIG. 2, there are illustrated characteristic curves indicating the relations between the operating frequency of the inverter circuit 40 and the maximum electric powers which can be inputted to the heating coils 48 and 49.

Referring to FIG. 2, the waveform W1 represents a frequency characteristic indicating the relation between the operating frequency of the inverter circuit 40 and the maximum electric power which can be inputted to the first heating coil 48, and the waveform W2 represents a frequency characteristic indicating the relation between the operating frequency of the inverter circuit 40 and the maximum electric power which can be inputted to the second heating coil 49. Further, the waveform W3 represents a frequency characteristic indicating the value of the sum of the maximum electric power which can be inputted to the first heating coil 48 and the maximum electric power which can be inputted to the second heating coil 49.

When a pan as a single to-be-heated object is heated by the two heating coils 48 and 49, the electric power supplied to the pan has a value equal to the value of the sum of the electric powers inputted to the two heating coils 48 and 49. Accordingly, the electric power indicated by the waveform W3 illustrated in FIG. 2 represents the total electric power supplied to the pan as the object to be heated.

When the operating frequency of the inverter circuit 40 falls in a frequency range higher than the resonance frequency of the first resonant circuit 56 constituted by the first heating coil 48 and the first resonant capacitor 50 and, also, falls in a frequency range higher than the resonance frequency of the second resonant circuit 57 constituted by the second heating coil 49 and the second resonant capacitor 51, if the operating frequency of the inverter circuit 40 is gradually lowered, the electric powers inputted to the two heating coils 48 and 49 are both gradually increased. Referring to FIG. 2, the frequency range which is higher than the resonance frequency of the first resonance circuit 56 and also is higher than the resonance frequency of the second resonance circuit 57 is indicated by hatching, wherein the range indicated by this hatching is an operating range. In the frequency characteristics illustrated in FIG. 2, the resonance frequency of the first resonance circuit 56 and the resonance frequency of the second resonance circuit 57 are both coincident with a frequency f1.

By setting the operating frequency in the aforementioned operating range, the value of the sum of the electric power inputted to the first heating coil 48 and the electric power inputted to the second heating coil 49 is determined, and the value of this sum is increased with decreasing operating frequency. Accordingly, by changing the operating frequency of the inverter circuit 40 within the operating range, it is possible to accurately and easily adjust the electric power supplied to the pan as the object to be heated.

The induction heating cooker is adapted to perform detection as to whether or not an object to be heated is being placed in the heating area on the top plate above the heating coils and, also, is adapted to make a determination as to which material forms the object to be heated placed thereon, based on the relation between the electric currents inputted to the heating coils and the operating frequency of the inverter circuit. In order to perform the detection and the determination, it is necessary that the relation between the operating frequency of the inverter circuit and the input electric currents has been grasped with higher accuracy, in advance. Further, in the induction heating cooker, in cases of selecting an operating frequency suitable for load characteristics of objects to be heated for driving it, and in cases of supplying constant electric power for heating objects to be heated of various types, similarly, it is desired that the operating frequency of the inverter circuit is accurately adjusted.

With the induction heating cooker according to the first embodiment, as described above, the relation between the heating electric power and the operating frequency is simplified due to the use of a certain operating range and, thus, can be easily standardized. Therefore, it is possible to perform detection and determinations regarding objects to be heated, with higher accuracy, based on the operating frequency of the inverter circuit 40 and the inputted electric currents. This enables performing proper heating operations in desired states.

The induction heating cooker according to the first embodiment is adapted to facilitate standardization of the relation between the operating frequency of the inverter circuit 40 and the electric power inputted to the heating coils, through the use of a certain range (operating range). Accordingly, with the induction heating cooker according to the first embodiment, it is possible to perform, anytime, proper induction heating according to loads, by applying it to a cooking device to be subjected to severe load fluctuations.

In the induction heating cooker according to the first embodiment, even though the electric currents flowed through the two heating coils 48 and 49 are controlled, the number of the switching devices 46 and 47 in the inverter circuit is not different from the number of switching devices in a conventional inverter circuit and, thus, the electric currents can be controlled through the two switching devices. Therefore, the induction heating cooker according to the first embodiment can be easily controlled and, also, has a simple circuit structure and, therefore, has an inexpensive structure which involves no increase of the manufacturing cost, while having sophisticated functions.

The induction heating cooker according to the first embodiment is structured to operate the inverter circuit 40 in a frequency range (an operating range) which is higher than the resonance frequency of the resonance circuits 56 and 57, as described above. Accordingly, in the inverter circuit 40, the phase of the electric current is delayed from the phase of the voltage, so that electric currents flow through the switching devices 46 and 47, at the time of the transitions of the switching devices 46 and 47 from a conducting state (ON) to a non-conducting state (OFF). The electric currents flowing at the time of the transitions are caused to flow through the snubber capacitor 53, so that the snubber capacitor 53 accumulates and discharges electrical charges therein and therefrom. Thus, due to such charging and discharging operations of the snubber capacitor 53, the voltages between the both ends of the switching devices 46 and 47 are stably changed with a constant ratio of change maintained. This results in reduction of the switching loss in each switching device 46 and 47, which is determined by the product of the voltage and the electric current in the switching device 46, 47. Accordingly, the induction heating cooker according to the first embodiment forms an energy-saving cooking device having higher electric-power conversion efficiency. Further, due to the provision of the snubber capacitor 53 as described above, it is possible to reduce the switching losses in the switching devices 46 and 47, which enables simplification of a heat dissipation structure for the switching devices 46 and 47.

### Second Embodiment

Hereinafter, an induction heating cooker according to a second embodiment of the present invention will be described. Further, the induction heating cooker according to the second embodiment has substantially the same structure as that of the induction heating cooker according to the aforementioned first embodiment. The induction heating cooker according to the second embodiment is different from the induction heating cooker according to the first embodiment, in terms of control operations of an inverter circuit. Accordingly, in the induction heating cooker according to the second embodiment, the components having substantially the same functions and the same structures as those of the induction heating cooker according to the first embodiment will be designated by the same reference characters and will not be described herein. The induction heating cooker according to the second embodiment has a structure similar to that of the induction heating cooker according to the aforementioned first embodiment illustrated in FIG. 1.

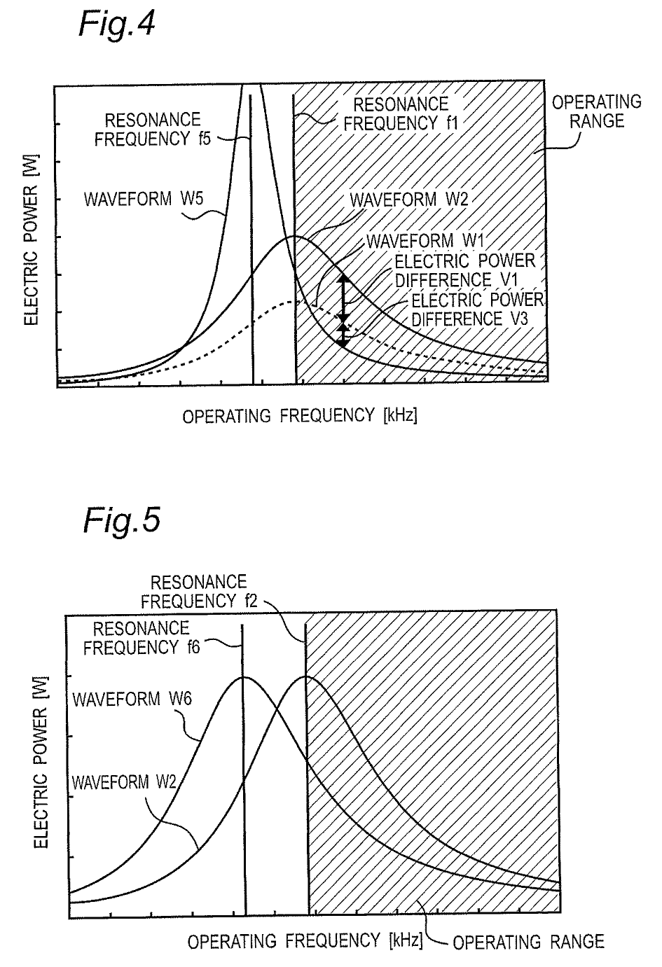

FIG. 3 and FIG. 4 are frequency-characteristics diagrams indicating the relation between the operating frequency of the inverter circuit 40 and the maximum electric powers which can be inputted to heating coils 48 and 49, in the induction heating apparatus in the induction heating cooker according to the second embodiment. In FIG. 3 and FIG. 4, the lateral axis represents the operating frequency [kHz], and the longitudinal axis represents the maximum electric power [W] which can be inputted to the heating coils 48 and 49.

In the frequency characteristics illustrated in FIG. 3, a waveform W1 and a waveform W2 represent frequency characteristics in a state where an object to be heated exists above both the first heating coil 48 and the second heating coil 49, similarly to the frequency characteristics illustrated in FIG. 2. A waveform W4 in FIG. 3 represents a frequency characteristic indicating the relation between the operating frequency of the inverter circuit 40 and the maximum electric power which can be inputted to the second heating coil 49, when no to-be-heated object exists above the second heating coil 49.

Next, with reference to the frequency characteristics illustrated in FIG. 3, there will be described control operations in the inverter circuit in the induction heating cooker according to the second embodiment.

The induction heating cooker according to the second embodiment is structured to heat an object to be heated, such as a single pan, which is placed in the heating area, by the two heating coils 48 and 49, wherein the first heating coil 48 is just beneath an inner side of the heating area of the top plate, and the second heating coil 49 is just beneath an outer side of the heating area of the top plate, similarly to the induction heating cooker according to the first embodiment. In the induction heating cooker having the aforementioned structure according to the second embodiment, when a pan as an object to be heated is placed in the heating area of the top plate, the pan exists above the first heating coil 48, but this pan may not exist above the second heating coil 49, depending on the size of this pan.

When the pan does not exist above the second heating coil 49 and, thus, there is no magnetic coupling between the second heating coil 49 and the pan, the second heating coil 49 has a decreased electrical resistance R between the both ends thereof and, also, has an increased inductance L thereof, in comparison with those of when there is magnetic coupling therebetween.

Accordingly, the resonance frequency f_{LC} is lowered, based on the relation indicated by the aforementioned equation (1). Accordingly, as indicated in FIG. 3, when there is no magnetic coupling between the second heating coil 49 and the pan, the resonance frequency f4 (the waveform W4) is lower than the resonance frequency f1 of when there is magnetic coupling therebetween.

In the induction heating cooker according to the second embodiment, the inverter circuit 40 is controlled, such that it operates in a frequency range (an operating range) which is higher than the resonance frequency f1, similarly to in the induction heating cooker according to the first embodiment. Therefore, the resonance frequency f4 in the waveform W4 is deviated from the operating frequency of the inverter circuit 40.

As illustrated in FIG. 3, when a pan exists above both the first heating coil 48 and the second heating coil 49, as indicated by the waveform W1 (the first heating coil 48) and the waveform W2 (the second heating coil 49), the electric power inputted to the second heating coil 49 is larger than the electric power inputted to the first heating coil 48 (see an electric-potential difference V1 in FIG. 3).

On the other hand, when a pan exists above the first heating coil 48 but the pan is not placed above the second heating coil 49, there are the waveform W1 (the frequency characteristic of the first heating coil 48) and the waveform W4 (the frequency characteristic of the second heating coil 49). In cases where such frequency characteristics are exhibited, when the operating range of the operating frequency of the inverter circuit 40 is set to be a frequency range higher than the resonance frequency f1, the electric power inputted to the second heating coil 49 is smaller than the electric power inputted to the first heating coil 48 (see an electric-potential difference V2 in FIG. 3).

Accordingly, in the induction heating cooker according to the second embodiment, since the inverter circuit 40 is operated in a frequency range higher than the resonance frequency f1, it is possible to automatically lower the electric power inputted to the second heating coil 49 above which the object to be heated does not exist, without necessitating complicated control, while maintaining the electric power inputted to the first heating coil 48 above which the object to be heated exists.

In the induction heating cooker according to the second embodiment, the inverter circuit 40 is driven and controlled as described above, which decreases the electric current in the second heating coil 49 which does not contribute to the heating since the object to be heated does not exist thereabove. Therefore, with the induction heating cooker according to the second embodiment, it is possible to largely suppress conduction losses induced by the electric current flowed through the coil wire in the second heating coil 49, thereby improving the heating efficiency.

Further, when the object to be heated is not placed above the second heating coil 49, the second heating coil 49 has a significantly-reduced resistance R between the both ends thereof, which increases the Q factor of the second resonant circuit 57 (see FIG. 1) which is constituted by the second heating coil 49 and the second resonant capacitor 51. As a result thereof, the frequency characteristic relating to the second heating coil 49 becomes equal to the frequency characteristic indicated by the waveform W4 in FIG. 3, and the electric power which can be inputted to the second heating coil 49 is significantly increased around the resonance frequency f4. This increased electric power is generated due to the absence of magnetic coupling between the second heating coil 49 and the object to be heated, and most of the energy generated in this case is consumed by the specific resistance of the coil wire in the second heating coil 49, thereby inducing conduction losses.

If the operating frequency of the inverter circuit is around the resonant frequency f4 in the waveform W4 illustrated in FIG. 3, an excessive electric current flows through the inverter circuit as described above, thereby destructing the inverter circuit. Therefore, in the induction heating cooker according to the second embodiment, the operating range of the operating frequency of the inverter circuit 40 is set to be a frequency range higher than the resonance frequency f1 of when the object to be heated is placed above the first heating coil 48 and the second heating coil 49, which can suppress the electric current flowed through the second heating coil 49 when the object to be heated is not placed above the second heating coil 49. This can certainly prevent the inverter circuit 40 from being destructed.

Further, in the induction heating cooker according to the second embodiment, when the object to be heated exists above the first heating coil 48 but does not exist above the second heating coil 49, it is possible to reduce the electric current flowed through the second heating coil 49 which does not contribute to the heating, which results in reduction of leaked magnetic fields, thereby suppressing electromagnetic noise exerted on other apparatuses and the like.

Next, there will be described control operations in the induction heating cooker according to the second embodiment, in the case of frequency characteristics illustrated in FIG. 4.

In the frequency characteristics illustrated in FIG. 4, a waveform W1 and a waveform W2 represent frequency characteristics in a state where an object to be heated exists above both the first heating coil 48 and the second heating coil 49, similarly to the frequency characteristics illustrated in FIG. 2 and FIG. 3. A waveform W5 in FIG. 4 represents a frequency characteristic indicating the relation between the operating frequency of the inverter circuit 40 and the maximum electric power which can be inputted to the second heating coil 49, when an object to be heated exists above the first heating coil 48 but the object to be heated exists only at a portion thereof above the second heating coil 49. Namely, the waveform W5 represents a frequency characteristic of when there is placed, above the second heating coil 49, an object to be heated which is slightly larger than the inner diameter of the second heating coil 49 but is smaller than the outer diameter of the second heating coil 49.

In the state indicated by the waveform W5, the second heating coil 49 is magnetically coupled to a portion of the object to be heated, so that the resonance frequency f5 in the waveform W5 illustrated in FIG. 4 is a frequency which is slightly higher than the resonance frequency f4 in the waveform W4 illustrated in FIG. 3 described above. However, even in the state of the waveform W5, the magnetic coupling between the object to be heated and the second heating coil 49 is still at a lower level, and the second resonant circuit 57 tends to have a higher Q factor.

In the state indicated by the waveform W5, electric power is supplied to the second heating coil 49 being magnetically coupled to a portion of the object to be heated, so that the electric-power difference V3 between the electric power inputted to the second heating coil 49 and the electric power inputted to the first heating coil 48 is smaller than an electric-power difference V2 (see FIG. 3). However, with the induction heating cooker according to the second embodiment, it is possible to offer the effect of reducing the electric power supplied to the second heating coil 49, similarly to in cases where no to-be-heated object is placed above the second heating coil 49.

The induction heating cooker according to the second embodiment has been described, regarding operations and effects thereof, in cases where no to-be-heated object is placed above the second heating coil 49, on the assumption that a pan (a pot) smaller than the diameter of the second heating coil 49 is heated.

With the induction heating cooker according to the second embodiment, it is possible to offer effects, in other cases than cases where a pot with a smaller diameter, as an object to be heated, is placed thereon. For example, in cases where a pan as an object to be heated has an inward concavity at the center of its pan bottom, the distance between this pan and the first heating coil 48 is larger than the distance between this pan and the second heating coil 49. In this case, the magnetic coupling between this pan and the first heating coil 48 is smaller than the magnetic coupling between this pan and the second heating coil 49. In this case, similarly, the resonance frequency of the first resonant circuit 56 including the first heating coil 48 having the smaller magnetic coupling thereto is lowered.

Accordingly, in the induction heating cooker according to the second embodiment, the operating frequency of the inverter circuit 40 is set such that it falls within a frequency range higher than any of the resonance frequencies f1 of when an object to be heated is placed above the first heating coil 48 and the second heating coil 49. Thus, when the magnetic coupling between the first heating coil 48 and the object to be heated is weak, similarly, it is possible to reduce the electric current flowed through the first heating coil 48, which realizes a structure capable of certainly preventing destruction of the inverter circuit 40 and, also, capable of improving the heating efficiency.

In the induction heating cooker according to the second embodiment, the power supply for the switching devices 46 and 47 in the inverter circuit 40 is constituted by a voltage source, and if a transition operation is performed for causing a transition of the first switching device 46 or the second switching device 47 in the inverter circuit 40 from an ON state to an OFF state, the high-frequency electric currents having been flowed through the heating coils 48 and 49 until just before the switching operation (the OFF operation) are caused to flow through the snubber capacitor 53, since the snubber capacitor 53 is connected, in parallel, to the second switching device 47. As a result thereof, the snubber capacitor 53 is caused to perform charging and discharging operations.

The voltage applied to the second switching device 47 is equal to the voltage between the both ends of the snubber capacitor 53 and, therefore, the voltage applied to the second switching device 47 is changed with a constant slope determined by the time constant of the snubber capacitor 53 and, therefore, is not abruptly changed. Namely, it is possible to prevent the occurrence of excessive voltages and excessive electric currents in the second switching device 47.

This results in reduction of the value of the product of the electric current flowed through the second switching device 47 and the voltage applied to the second switching device 47, thereby reducing switching losses induced by switching operations of the second switching device 47.

Further, the voltage applied to the first switching device 46 has a value equal to the value of the electric-potential difference between the positive bus line and the negative bus line minus the voltage between the both ends of the snubber capacitor 53 and, therefore, the voltage applied to the first switching device 46 is changed with a constant slope and is not abruptly changed, similarly to the voltage applied to the second switching device 47.

In the inverter circuit 40, in order to perform switching operations (OFF operations) within time periods during which electric currents flow through the switching devices 46 and 47, it is necessary to perform the switching operations (the OFF operations) earlier than the occurrences of reverses of the electric currents flowing through the resonant circuits 56 and 57 including the heating coils 48 and 49 due to resonance. In order to attain this, it is necessary to set the operating frequency of the inverter circuit 40 to be higher than the resonance frequencies.

If the operating frequency of the inverter circuit 40 is a frequency lower than both the resonance frequency of the first resonant circuit 56 and the resonance frequency of the second resonant circuit 57, the switching operations (the OFF operations) should be performed, within time periods during which the electric currents flowing through the resonant circuits 56 and 57 are flowed through the reverse conducting diodes 54 and 55 which are connected in parallel to the switching devices 46 and 47. This makes it impossible to reduce the switching losses in the switching devices 46 and 47.

Further, if the operating frequency of the inverter circuit 40 falls in a frequency range between the resonance frequency of the first resonant circuit 56 constituted by the first heating coil 48 and the first resonant capacitor 50 and the resonance frequency of the second resonant circuit 57 constituted by the second heating coil 49 and the second resonant capacitor 51, this will induce problems as follows.

In the single resonant circuit for which the inverter circuit 40 is operated at a higher frequency than the resonance frequency thereof, switching operations (OFF operations) are performed, in a state where electric currents flow through the switching devices and, therefore, in a preferable state. However, in the other resonant circuit for which the inverter circuit 40 is operated at a lower frequency than the resonance frequency thereof, the switching operations (the OFF operations) should be performed in a state where electric currents flow through the reverse conducting diodes which are connected reversely in parallel to the switching devices, which makes it impossible to reduce switching losses.

In the induction heating cooker according to the second embodiment, the sum of the electric currents in the two resonant circuits 56 and 57 is flowed through the inverter circuit 40. Therefore, in a state where electric currents flow through the two resonant circuits 56 and 57, if the electric current flowing through the resonant circuit having the lower resonance frequency is larger than the electric current flowing through the resonant circuit having the higher resonance frequency, the switching operations (the OFF operations) should be performed while electric currents flow through the switching devices. In this case, it is possible to suppress switching losses induced in the switching devices.

However, in the opposite case where the electric current flowing through the resonant circuit having the lower resonance frequency is smaller than the electric current flowing through the resonant circuit having the higher resonance frequency, the switching operations should be performed in a state where electric currents flow through the reverse conducting diodes. Accordingly, whether or not operations can be performed in such a way as to suppress switching losses depends on various types of parameters about the plurality of resonant circuits, which makes it hard to stably perform operations in such a way as to suppress switching losses.

Therefore, the induction heating cooker according to the second embodiment is structured such that the operating frequency of the inverter circuit 40 falls in a range which is higher than both the resonance frequency of the first resonant circuit 56 constituted by the first heating coil 48 and the first resonant capacitor 50 and the resonance frequency of the second resonant circuit 57 constituted by the second heating coil 49 and the second resonant capacitor 51. With this structure, it is possible to perform switching operations (OFF operations), in a state where all the electric currents flowing through the resonant circuits 56 and 57 are flowed through the switching devices 46 and 47, thereby reducing switching losses due to the switching operations.

Further, with the induction heating cooker according to the second embodiment, it is possible to suppress abrupt changes in the voltages applied to the switching devices, which can suppress the occurrence of electromagnetic noise. This can eliminate the necessity of provision of components required for measures for electromagnetic noise suppression, thereby reducing the cost required for such components.

Further, the description about the induction heating cooker according to the second embodiment completely holds when the duty ratio is 0.5, but this cannot hold with a higher probability, as the duty ratio is decreased or increased therefrom. For example, even when the operating frequency of the inverter circuit 40 is higher than the resonance frequencies of the resonant circuits 56 and 57, as the duty ratio is deviated from the value of 0.5, the electric currents flowing through the switching devices having longer conduction time periods (ON time periods) may shift to a diode conduction state with a higher probability. Accordingly, the control operations in the inverter circuit 40 in the induction heating cooker according to the second embodiment cannot hold for all duty ratios.

However, the control operations in the induction heating cooker according to the second embodiment are a certain means and, also, are an effective means, at least when the duty ratio is to 0.5, namely in a range where larger electric currents flow to induce larger switching losses.

### Third Embodiment

Hereinafter, an induction heating cooker according to a third embodiment of the present invention will be described. Further, the induction heating cooker according to the third embodiment has substantially the same structure as that of the induction heating cooker according to the aforementioned first embodiment. The induction heating cooker according to the third embodiment is different from the induction heating cooker according to the first embodiment, in terms of control operations of an inverter circuit. Accordingly, in the induction heating cooker according to the third embodiment, the components having substantially the same functions and the same structures as those of the induction heating cooker according to the first embodiment will be designated by the same reference characters and will not be described herein. The induction heating cooker according to the third embodiment has a structure similar to that of the induction heating cooker according to the aforementioned first embodiment illustrated in FIG. 1.

In the induction heating cooker according to the third embodiment, the resonance frequency of the first resonant circuit 56 including the first heating coil 48 has a value different from the value of the resonance frequency of the second resonant circuit 57 including the second heating coil 49. The present embodiment is different from the aforementioned first and second embodiments, in that the first resonant circuit 56 and the second resonant circuit 57 have different resonance frequencies.

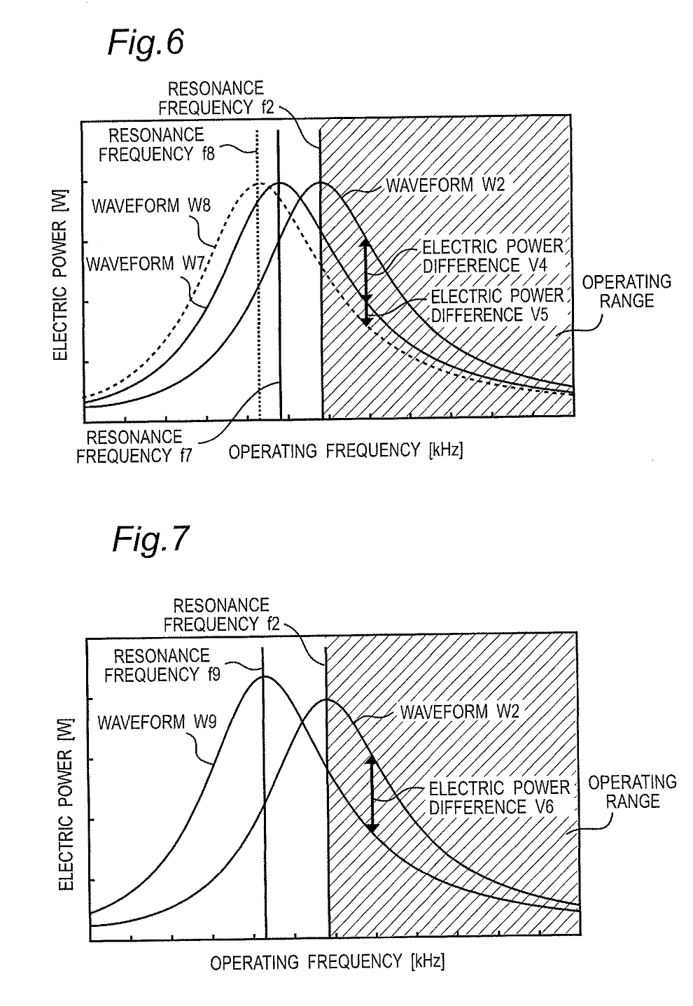

FIG. 5, FIG. 6 and FIG. 7 are frequency-characteristics diagrams representing the relations between the operating frequency of the inverter circuit 40 and the maximum electric powers which can be inputted to respective heating coils 48 and 49, in the induction heating cooker according to the third embodiment. In FIG. 5, FIG. 6 and FIG. 7, the lateral axis represents the operating frequency [kHz], and the longitudinal axis represents the maximum electric power [W] which can be inputted to the heating coils 48 and 49.

FIG. 5, FIG. 6 and FIG. 7 illustrate frequency characteristics of when there is placed, in a heating area above the second heating coil 49, a pan as an object to be heated which has a diameter larger than the diameter of the second heating coil 49 outside the first heating coil 48. Referring to FIG. 5, FIG. 6 and FIG. 7, a waveform W2 indicates a frequency characteristic in a state where the object to be heated exists above the second heating coil 49, similarly to the frequency characteristics illustrated in FIG. 2.

With reference to the frequency characteristics illustrated in FIGS. 5, 6 and 7, there will be described control operations in the inverter circuit in the induction heating apparatus in the induction heating cooker according to the third embodiment.

FIG. 5 illustrates the relations between the operating frequency of the inverter circuit 40 and the maximum electric powers which can be inputted to the respective heating coils 48 and 49, when the resonance frequency f6 (a waveform W6) of the first resonant circuit 56 including the first heating coil 48 and the resonance frequency f2 (the waveform W2) of the second resonant circuit 57 including the second heating coil 49 are made to have different values.

In the induction heating cooker according to the third embodiment, as an operating range of the operating frequency of the inverter circuit 40, a frequency range higher than the highest resonance frequency is employed. In the induction heating cooker according to the third embodiment, the inverter circuit 40 is operated in a frequency range higher than the resonance frequency f2, which is the higher resonance frequency out of the two resonance frequencies. This can offer effects of the present invention.

The frequency-characteristics diagram illustrated in FIG. 6 indicates effects of the different resonance frequencies of the plurality of resonant circuits. Referring to FIG. 6, the waveform W2 represents the relation between the operating frequency of the inverter circuit 40 and the maximum electric power which can be inputted to the second heating coil 49, and a waveform W7 represents the relation between the operating frequency of the inverter circuit 40 and the maximum electric power which can be inputted to the first heating coil 48.

In the induction heating cooker according to the third embodiment, at first, in order to cause the respective resonant circuits 56 and 57 to have different resonance frequency values, the capacitances of the first resonant capacitor 50 and the second resonant capacitor 51 constituting the respective resonant circuits 56 and 57 including the heating coils 48 and 49 are changed. It is obvious, from the aforementioned equation (1), that the resonance frequencies can be changed by changing the capacitances of the resonant capacitors 50 and 51 as described above.

The frequency characteristics relating to the maximum electric powers which can be inputted to the heating coils 48 and 49, the electric powers which can be inputted to the heating coils by operating the inverter circuit 40 at a certain frequency deviated from the resonance frequencies, and the like, namely the frequency characteristics represented by the waveform W2, the waveform W7 and the like in FIG. 6, are determined by the shapes of the heating coils 48 and 49, the state of the magnetic coupling between the heating coils 48 and 49 and the object to be heated (the pan), and the like. Therefore, it is extremely hard to design, in advance, the heating coils 48 and 49 such that they exhibit desired frequency characteristics.

However, in cases where a certain frequency characteristic (for example, the waveform W7 relating to the first heating coil 48 illustrated in FIG. 6) can be obtained, it is possible to change the resonance frequency (f7) in this frequency characteristic, by changing the capacitance of the resonant capacitor (51).

Accordingly, for example, as illustrated in FIG. 6, when the electric power inputted to the first heating coil 48 has a characteristic represented by the waveform W7, and the electric power inputted to the second heating coil 49 has a characteristic represented by the waveform W2, there is an electric-potential difference V4 between the waveform W2 and the waveform W7, in a frequency range higher than the resonance frequency f2 in the waveform W2. However, when it is desired that the electric power inputted to the first heating coil 48 is decreased, it is possible to cause a shift from the waveform W7 to a waveform W8 (the resonance frequency f8 is smaller than f7), by increasing the capacitance of the first resonant capacitor 50 in the first resonant circuit 56 including the first heating coil 48. As a result thereof, in cases where the inverter circuit 40 is operated at the same frequency, the electric power inputted to the first heating coil 48 is decreased, thereby resulting in an increased electric-power difference V5 (V5>V4), in comparison with the electric power inputted to the second heating coil.

By setting the resonance frequencies of the resonant circuits 56 and 57 to be different values, as described above, it is possible to set the difference between the electric powers to the two heating coils 48 and 49, and the electric power ratio therebetween, regardless of characteristics of the two heating coils 48 and 49. Accordingly, in the third embodiment, it is possible to provide an induction heating cooker having a higher degree of flexibility in designing.

As effects of the induction heating cooker according to the third embodiment, for example, it is possible to uniformly heat objects to be heated without inducing unevenness, by adjusting the ratio of the electric powers inputted to the object to be heated from the respective heating coils 48 and 49. This results in provision of an induction heating cooker with excellent usability.

Further, by changing the electric powers inputted to the heating coils 48 and 49, the electric currents flowed through the respective heating coils 48 and 49 are changed. Therefore, for example, when the first heating coil 48 provided inside the second heating coil 49 generates a larger amount of heat and, therefore, it is hard to cool the first heating coil 48, it is possible to decrease the electric power supplied to the object to be heated from the first heating coil 48 for decreasing the electric current flowed through the first heating coil 48, thereby suppressing temperature rises in the first heating coil 48. As a result thereof, with the induction heating cooker according to the third embodiment, it is possible to cool the heating coils through adjustments of the electric power ratio therebetween, thereby providing a cooking device with excellent reliability.

Further, in cases of reducing the electric power supplied to the object to be heated from the first heating coil 48, as described above, if it is not desired that the sum of the electric powers inputted to the two heating coils 48 and 49 is changed, it is necessary to set the operating frequency of the inverter circuit 40 to be slightly lower.

FIG. 7 illustrates a case where the maximum electric power which can be inputted to the first heating coil 48 (a waveform W9) is larger than the maximum electric power which can be inputted to the second heating coil 49 (the waveform W2). In such a case, similarly, by causing the resonance frequencies of the respective resonant circuits 56 and 57 including the heating coils 48 and 49 to have different values (f2, f9), it is possible to set the electric-power difference V6 between the first heating coil 48 and the second heating coil 49 to be a desired value, thereby causing the ratio between the electric powers inputted to the first heating coil 48 and the second heating coil 49 to have a desired value.

Accordingly, with the induction heating cooker according to the third embodiment, regardless of characteristics of the two heating coils 48 and 49 which are determined by their diameters and shapes, it is possible to adjust the ratio between the electric powers to the first heating coil 48 and the second heating coil 49 at a predetermined operating frequency, by changing the capacitance of the first resonant capacitor 50, for example, for changing the resonance frequency thereof

Further, with the induction heating cooker according to the third embodiment, it is also possible to offer the same effects, by changing the capacitance of the second resonant capacitor 51, as well as by changing the capacitance of the first resonant capacitor 50.

Further, in the induction heating cooker according to the third embodiment, in cases of preliminarily designing the heating coils 48 and 49 such that they exhibit desired frequency characteristics when the heating coils 48 and 49 are magnetically coupled to a representative to-be-heated object (a pan), while fixing the capacitances of the first resonant capacitor 50 and the second resonant capacitor 51, it is possible to offer the same effects, at least when the representative to-be-heated object and an object to be heated having similar properties thereto are heated.

Further, while the induction heating cooker according to the third embodiment has been described, with respect to a case where the electric power inputted to the first heating coil 48 is decreased, it is also possible to increase the electric power inputted to the first heating coil 48 by changing characteristics, similarly. Namely, in cases of changing the capacitance of the first resonant capacitor 50 or the second resonant capacitor 51 in the induction heating cooker according to the third embodiment of the present invention, there is no need for fabricating the plurality of heating coils in such a way as to preliminarily adjust their characteristics, and it is possible to easily and accurately change the ratio of the electric powers which can be inputted to the plurality of heating coils, in an assembled state. On the contrary, in cases of changing the capacitance of neither the first resonant capacitor 50 nor the second resonant capacitor 51 in the induction heating cooker according to the third embodiment of the present invention, it is possible to preliminarily design the heating coils 48 and 49 for a representative to-be-heated object, which eliminates the necessity of providing a means for changing the capacitance of the first resonant capacitor 50 or the second resonant capacitor 51, thereby enabling structuring the induction heating cooker with lower costs.

### Fourth Embodiment

Hereinafter, an induction heating cooker according to a fourth embodiment of the present invention will be described. Further, the induction heating cooker according to the fourth embodiment has substantially the same structure as that of the induction heating cooker according to the aforementioned first embodiment. The induction heating cooker according to the fourth embodiment is different from the induction heating cooker according to the first embodiment, in terms of control operations of an inverter circuit. Accordingly, in the induction heating cooker according to the fourth embodiment, the components having substantially the same functions and the same structures as those of the induction heating cooker according to the first embodiment will be designated by the same reference characters and will not be described herein. The induction heating cooker according to the fourth embodiment has a structure similar to that of the induction heating cooker according to the aforementioned first embodiment illustrated in FIG. 1.

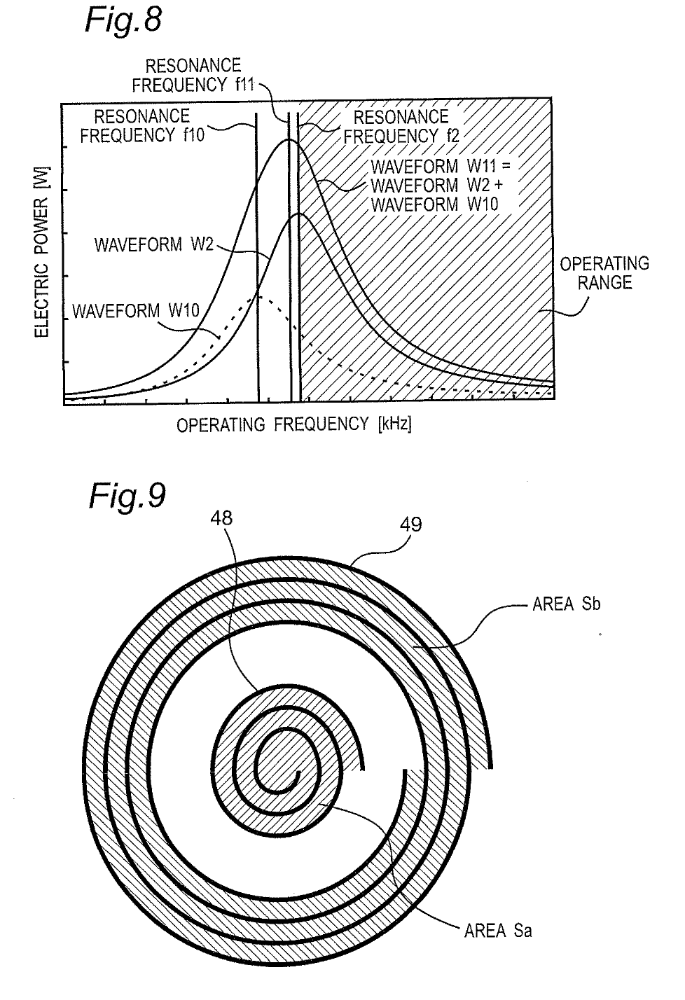

FIG. 8 is a frequency-characteristics diagram representing the relation between the operating frequency of the inverter circuit and the maximum electric powers which can be inputted to respective heating coils, in the induction heating apparatus in the induction heating cooker according to the fourth embodiment. In FIG. 8, the lateral axis represents the operating frequency [kHz], and the longitudinal axis represents the maximum electric power [W] which can be inputted to the heating coils 48 and 49.

Referring to FIG. 8, the resonance frequency (f10) of a first resonant circuit 56 including the first heating coil 48 is lower than the resonance frequency (f2) of a second resonant circuit 57 including the second heating coil 49. Further, the peak (the maximum electric power at the resonance frequency f10) of the maximum electric power inputted to the first heating coil 48 (a waveform W10) is smaller than the peak (the maximum electric power at the resonance frequency f2) of the electric power inputted to the second heating coil 49 (a waveform W2). The fourth embodiment is different from the aforementioned first to third embodiments, in terms of the aforementioned facts. Referring to FIG. 8, a waveform W11 represents, in the form of a waveform, the value of the sum of the frequency characteristics represented by the waveform W2 and the waveform W10. The resonance frequency f11 in the frequency characteristic represented by the waveform 11 is lower than the resonance frequency f2 in the waveform W2. Accordingly, any frequency range higher than the resonance frequency f2 in the waveform W2 is a frequency range higher than the resonance frequency f11 in this waveform W11, as a matter of course.

With reference to the frequency characteristics illustrated in FIG. 8, there will be described control operations in the inverter circuit in the induction heating cooker according to the fourth embodiment.

The conduction loss in a heating coil is induced by the electric current flowed through the heating coil and the specific resistance of the coil wire in the heating coil. The conduction loss [electric power: W] is proportional to the square of the electric current. In order to reduce the conduction loss in the heating coil, reducing the electric current flowed through the heating coil is effective. To attain this, it is necessary to increase the resistance R of the heating coil above which an object to be heated exists. There is the relationship expressed by the following equation (2), between the maximum electric power P and the power supply voltage E.

[Equation 2]

P=E²/R (2)

Thus, if the resistance R of the heating coil is increased in a state where an object to be heated exists above the heating coil, this increases the difficulty in inputting electric power to this heating coil.

For the sake of decreasing the electric currents flowed through the heating coils, in order to enhance the magnetic coupling between the heating coils and the object to be heated, and in order to input electric power to the heating coils designed to have such increased resistances R, it is necessary to operate the inverter circuit around the resonance frequencies at which inputting of electric power thereto is easier.

Accordingly, in the induction heating cooker according to the fourth embodiment, the inverter circuit 40 is operated around the resonance frequency f2 of the second heating coil 49 to which larger electric power is inputted, which enables designing the heating coil to have a larger resistance R. Therefore, with the induction heating cooker according to the fourth embodiment, it is possible to flow a smallest possible electric current through the heating coil to which larger electric power is inputted, namely the heating coil through which a larger electric current should be flowed, thereby ensuring desired electric power. Thus, in the fourth embodiment, it is possible to perform control operations capable of reducing the conduction losses in the heating coils, with the induction heating cooker including the heating coils designed to have larger resistances R.

Further, in the induction heating cooker according to the fourth embodiment, the operating range of the inverter circuit is set to be a frequency range higher than the resonance frequency f2 of the second heating coil 49 to which larger electric power is inputted, which can offer the same effects as the effects described in the aforementioned first to third embodiments, thereby enabling proper induction heating according to loads.

Further, in the induction heating cooker according to the fourth embodiment, particularly, when the duty ratio of switching operations of the switching devices 46 and 47 is close to 0.5, if the operating frequency of the inverter circuit 40 is closer to the resonance frequency (f2), the electric currents flowed through the switching devices 46 and 47 just before the operations of the switching devices 46 and 47 (just before the OFF operations) are smaller, which can suppress switching losses.

The induction heating cooker according to the fourth embodiment is adapted to be driven by the inverter circuit 40 including the common switching devices 46 and 47 for the two heating coils 48 and 49. The proportion of the electric current flowed through the second heating coil 49, to which larger electric power is inputted, to the electric currents flowed through the respective switching devices 46 and 47 is higher. Therefore, by setting the operating frequency to be around the resonance frequency 12 of the second resonant circuit 57 including the second heating coil 49 to which larger electric power is inputted, it is possible to reduce the switching losses induced at the time of operations of the switching devices 46 and 47.

### Fifth Embodiment

Hereinafter, an induction heating cooker according to a fifth embodiment of the present invention will be described. Further, the induction heating cooker according to the fifth embodiment has substantially the same structure as that of the induction heating cooker according to the aforementioned first embodiment. The induction heating cooker according to the fifth embodiment is different from the induction heating cooker according to the first embodiment, in terms of control operations of an inverter circuit and the structure of heating coils. Accordingly, in the induction heating cooker according to the fifth embodiment, the components having substantially the same functions and the same structures as those of the induction heating cooker according to the first embodiment will be designated by the same reference characters and will not be described herein. The induction heating cooker according to the fifth embodiment has a structure similar to that of the induction heating cooker according to the aforementioned first embodiment illustrated in FIG. 1.

FIG. 9 is a plan view illustrating the general shape of the heating coils in the induction heating apparatus in the induction heating cooker according to the fifth embodiment.

In the induction heating cooker according to the fifth embodiment, the ratio between the values of electric powers inputted to the two heating coils 48 and 49 illustrated in FIG. 9 has a value corresponding to the respective areas (Sa, Sb) of the two heating coils 48 and 49 which are faced to the object to be heated.

Next, there will be described control operations in the inverter circuit in the induction heating apparatus in the induction heating cooker according to the fifth embodiment.

Referring to FIG. 9, in a state where the object to be heated is placed above the first heating coil 48 and the second heating coil 49, it is assumed that the area of the first heating coil 48 which is faced to the object to be heated is “Sa”, and the area of the second heating coil 49 which is faced to the object to be heated is “Sb”. The ratio between the facing area Sa of the first heating coil 48 and the facing area Sb of the second heating coil 49 is about 1:3. In this case, assuming that the sum of the electric powers inputted to the first heating coil 48 and the second heating coil 49, namely the electric power inputted to the single to-be-heated object, is 3 kW, the electric power Pa inputted to the first heating coil 48 and the electric power Pb inputted to the second heating coil 49 are set as follows.

[Equation 3]

Pa=3 kW×Sa/(Sa+Sb)=0.75 kW (3)

[Equation 4]

Pb=3 kW×Sb/(Sa+Sb)=2.25 kW (4)

In the induction heating cooker according to the fifth embodiment, as described above, the electric-power ratio (Pa/Pb) between the electric power Pa inputted to the first heating coil 48 and the electric power Pb inputted to the second heating coil 49 is controlled, such that it is coincident with the ratio (Sa/Sb) between the facing area Sa of the first heating coil 48 and the facing area Sb of the second heating coil 49.

In induction heating operations, the magnetic fields generated from the heating coils are applied to the object to be heated placed at a position facing the heating coils, so that the object to be heated generates heat. Therefore, in induction heating operations, the object to be heated is heated in substantially the same shape as the planar shape of the heating coils (the shape of their surfaces facing the object to be heated).

Further, the density of electric power inputted to the object to be heated is substantially constant over the heating coils. Therefore, the value of the electric power inputted to the heating coils which is divided by the area of the facing surfaces of the heating coils which are faced to the object to be heated is coincident with the density of electric power in the facing surface of the object to be heated placed above the heating coils.

In the induction heating cooker according to the fifth embodiment, the electric-power ratio (Pa/Pb) is set as described above, so that the density of electric power inputted to the object to be heated placed above the first heating coil 48 in the facing area thereof is equal to the density of electric power inputted to the object to be heated placed above the second heating coil 49 in the facing area thereof.

In the induction heating cooker having the aforementioned structure according to the fifth embodiment, even though a single to-be-heated object is heated using the plurality of heating coils, it is possible to substantially equalize the temperatures at respective portions of the object to be heated existing above the respective heating coils. As a result thereof, with the induction heating cooker according to the fifth embodiment, it is possible to uniformly heat the object to be heated, thereby improving the cooking performance.

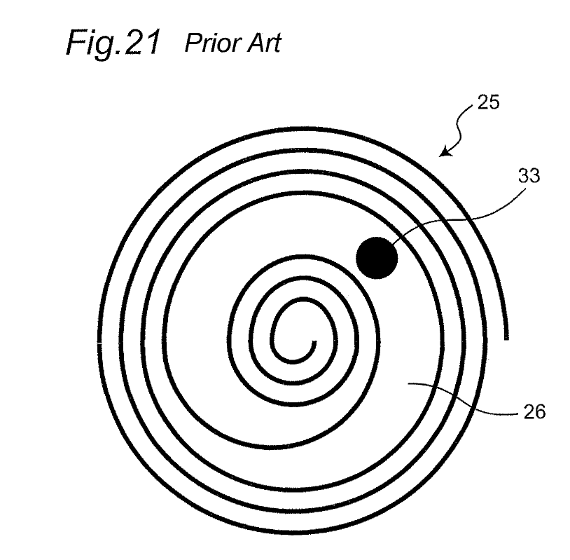

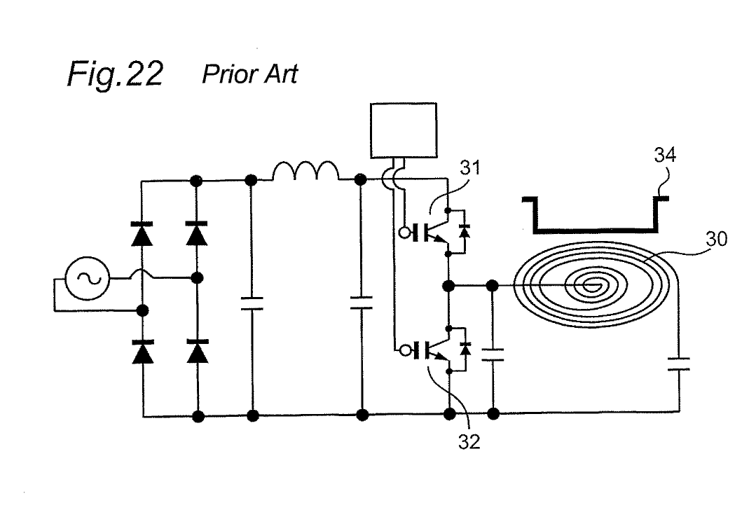

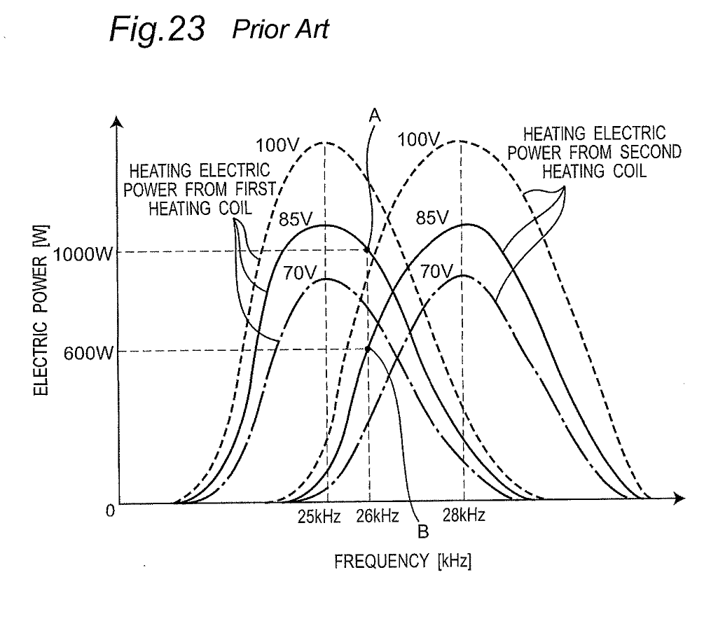

In the conventional heating coil 25 having a split-winding shape illustrated in FIG. 21, which has been described in the aforementioned section of the background art, a uniform electric current is flowed through the heating coil 25. Therefore, the electric-power ratio between the inner coil and the outer coil can be changed, only by adjusting the number of windings in the heating coil 25, the thickness of the heating coil 25 and the like.

Even if the number of windings, the thickness and the like of the heating coil 25 having the conventional split-winding shape illustrated in FIG. 21 are adjusted for setting the electric-power ratio, it is impossible to set the shape and the size of the heating coil 25, such as the diameter, the number of windings, the thickness thereof, to be desired values, and this heating coil 25 has no degree of flexibility in designing.

The induction heating cooker according to the fifth embodiment is adapted to enable adjusting the ratio between the electric powers inputted to the heating coils 48 and 49, through control operations, rather than through the shapes and the sizes of the heating coils 48 and 49. This enables placing a temperature sensor for detecting the temperature of the object to be heated, for example, at an arbitrary position near the heating coils. Further, with the induction heating cooker according to the fifth embodiment, even when the heating coils 48 and 49 are structured such that they are wound with a constant thickness, it is possible to uniformize the magnetic flux density, thereby realizing uniform heating.

Further, while the induction heating cooker according to the fifth embodiment has been described with respect to control operations in such a way as to make the ratio between the facing areas of the heating coils 48 and 49 completely coincident with the ratio between the electrical powers inputted to the respective heating coils 48 and 49, the present invention is not limited to such control operations. In the induction heating cooker, the object to be heated may be heated more uniformly, by setting the ratio between the electric powers inputted to the respective heating coils to be a value slightly deviated from the ratio between the facing areas of the respective heating coils, in some cases, depending on the degree of cooling for the respective heating coils, the degree of heat dissipation from the object to be heated being heated, the size of the object to be heated, and the like. Therefore, the induction heating cooker according to the present invention also includes those capable of adjusting the electric-power ratio, according to various types of situations as described above.

Experiments conducted by the present inventors revealed that the ratio between the facing areas of the heating coils and the ratio between electrical powers inputted to the heating coils were deviated from with each other, by about 20% or less. This fact indicates that, when the ratio between the facing areas of the two heating coils 48 and 49 is about 1:3 as in the fifth embodiment, for example, even though there is a deviation of 20% as described above, the electric power inputted to the first heating coil 48 having the smaller facing area does not exceed the electric power inputted to the second heating coil 49 having the larger facing area.

### Sixth Embodiment

Hereinafter, an induction heating cooker according to a sixth embodiment of the present invention will be described. Further, the induction heating cooker according to the sixth embodiment has substantially the same structure as that of the induction heating cooker according to the aforementioned first embodiment. The induction heating cooker according to the sixth embodiment is different from the induction heating cooker according to the first embodiment, in terms of the structures (the cross-sectional shapes) of heating coils. Accordingly, in the induction heating cooker according to the sixth embodiment, the components having substantially the same functions and the same structures as those of the induction heating cooker according to the first embodiment will be designated by the same reference characters and will not be described herein. The induction heating cooker according to the sixth embodiment has a structure similar to that of the induction heating cooker according to the aforementioned first embodiment illustrated in FIG. 1.

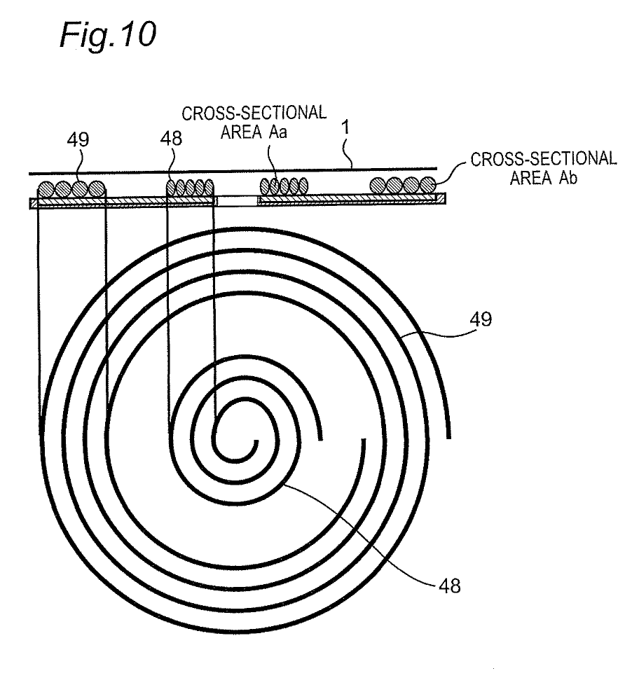

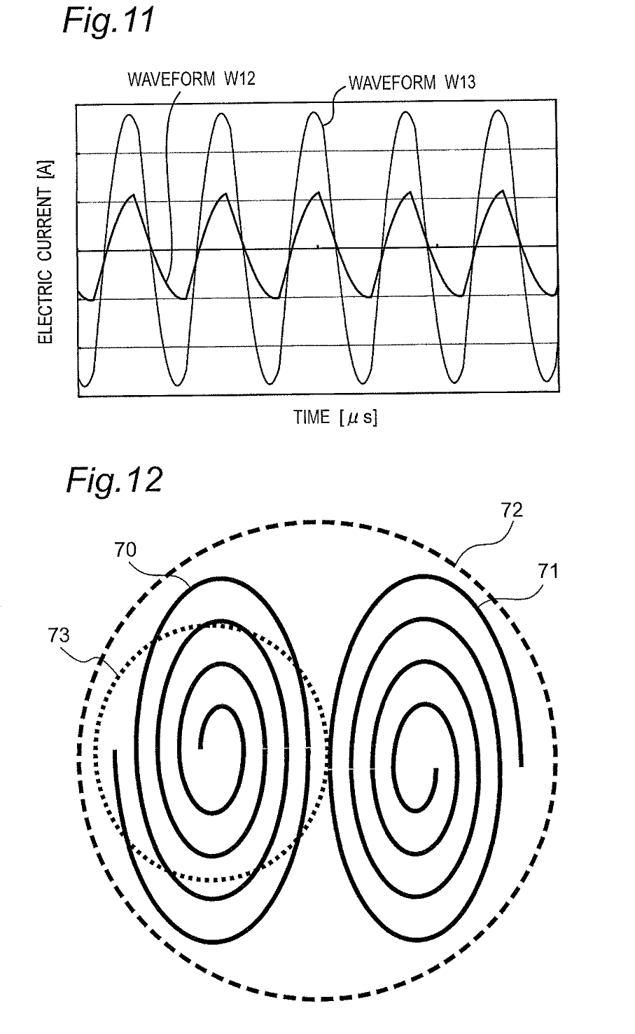

FIG. 10 is a view illustrating the shapes of the heating coils and the cross-sectional areas of the heating coils, in the induction heating apparatus in the induction heating cooker according to the sixth embodiment. FIG. 11 is a view illustrating the waveforms of electric currents flowed through the heating coils in the induction heating apparatus in the induction heating cooker according to the sixth embodiment.

As illustrated in FIG. 10, the first heating coil 48 and the second heating coil 49 are formed from respective coil wires having different cross-sectional shapes (cross-sectional areas) orthogonal to the directions in which electric currents flow therethrough (the directions of windings), wherein the cross-sectional area of the first heating coil 48 is smaller than the cross-sectional area of the second heating coil 49. In the induction heating cooker according to the sixth embodiment, the ratio between the electric currents flowed through the first heating coil 48 and the second heating coil 49 has a value corresponding to the cross-sectional areas of the coil wires forming the respective heating coils 48 and 49. The induction heating cooker according to the present embodiment is different from the induction heating cookers according to the aforementioned first to fifth embodiments, in terms of this fact.

Referring to FIG. 10, the cross-sectional area of the coil wire forming the first heating coil 48 and the cross-sectional area of the coil wire forming the second heating coil 49 are cross-sectional areas of the first heating coil 48 and the second heating coil 49 which are sectioned vertically with respect to the heating area surface of the top plate on which an object to be heated is placed. Referring to FIG. 10, it is assumed that the cross-sectional area of the coil wire forming the first heating coil 48 is Aa, and the cross-sectional area of the coil wire forming the second heating coil 49 is Ab.

FIG. 11 illustrates the waveform (W12) of an electric current flowed through the first heating coil 48, and the waveform (W13) of an electric current flowed through the second heating coil 49. In the induction heating cooker according to the sixth embodiment, the ratio between the electric currents flowed through the respective heating coils 48 and 49 is made to have a value coincident with the ratio between the cross-sectional areas of the coil wires forming the respective heating coils 48 and 49.

There will be described operations of the induction heating apparatus in the induction heating cooker having the aforementioned structure according to the sixth embodiment.

The losses induced by the respective coil wires in the heating coils 48 and 49 depend on the electric currents flowed through the heating coils 48 and 49. As illustrated in FIG. 11, the electric currents flowed through the two heating coils 48 and 49 have waveforms (W12, W13) different from each other, and the waveform W12 of the electric current flowed through the first heating coil 48 has a peak electric current which is smaller than that of the waveform W13 of the electric current flowed through the second heating coil 49. Further, due to the presence of the large difference between these peak electric currents, it can be determined that the electric current having an effective value which flows through the first heating coil 48 and contributes to the loss induced in the coil wire is less than the electric current having an effective value which flows through the second heating coil 49.

Due to the magnetic coupling between the respective heating coils 48 and 49 and the object to be heated, the heating coils 48 and 49 have different resistances R, in a state where the object to be heated is placed thereabove. Further, the respective resonant circuits 56 and 57 having the two heating coils 48 and 49 have different resonance frequencies, so that the waveform W12 of the electric current flowed through the first heating coil 48 is different from the waveform W12 of the electric current flowed through the second heating coil 49.

In the induction heating cooker according to the sixth embodiment, electric currents having different values are flowed through the first heating coil 48 and the second heating coil 49, and the cross-sectional areas of the respective heating coils 48 and 49 have values corresponding to the electric currents flowed through the respective heating coils 48 and 49. Thus, in the induction heating cooker according to the sixth embodiment, the respective heating coils 48 and 49 are structured as described above, wherein the first heating coil 48 through which a smaller electric current is flowed is made to have a smaller cross-sectional area. This enables reduction of the amount of copper used in the first heating coil 48, thereby enabling manufacture of the first heating coil with lower costs.

Even when it is desired to increase the numbers of windings in the coil wires in the heating coils, in order to increase the resistances R of the heating coils in a state where an object to be heated is placed thereabove, it has been impossible to increase the numbers of windings while maintaining the same cross-sectional areas, under a condition where there are constraints on the outer diameters and the thicknesses of the heating coils. However, in the induction heating cooker according to the sixth embodiment, the heating coil to which smaller electric power is inputted is structured to have a smaller cross-sectional area, which enables increasing the number of winding in the heating coil without changing the outer diameter and the thickness thereof, thereby increasing the resistance R of the heating coil.

### Seventh Embodiment

Hereinafter, an induction heating cooker according to a seventh embodiment of the present invention will be described. Further, the induction heating cooker according to the seventh embodiment is structured to include a plurality of heating coils which are juxtaposed in a single heating area, but the other portions have substantially the same structures as those of the induction heating cooker according to the aforementioned first embodiment and, further, are adapted to be controlled in the same manner thereas. Accordingly, in the induction heating cooker according to the seventh embodiment, the components having substantially the same functions and the same structures as those of the induction heating cooker according to the first embodiment will be designated by the same reference characters and will not be described herein. The induction heating cooker according to the seventh embodiment has a structure similar to that of the induction heating cooker according to the aforementioned first embodiment illustrated in FIG. 1, except the structures of the heating coils therein.

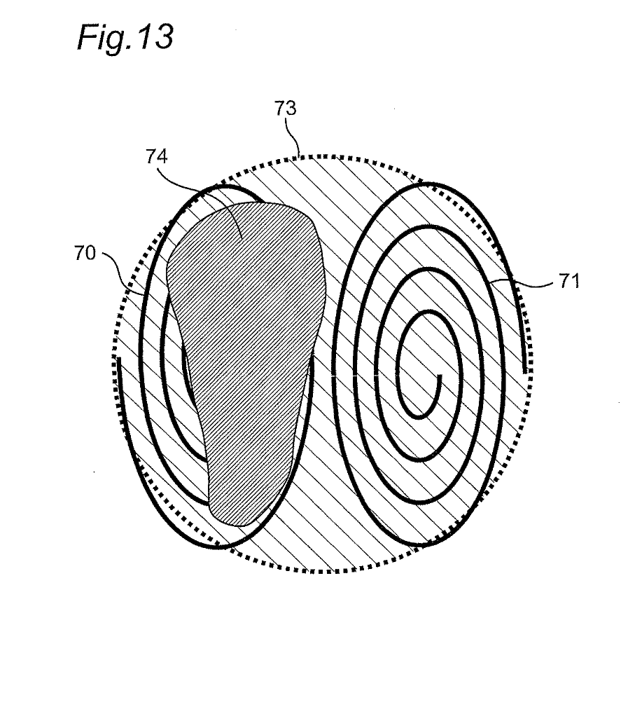

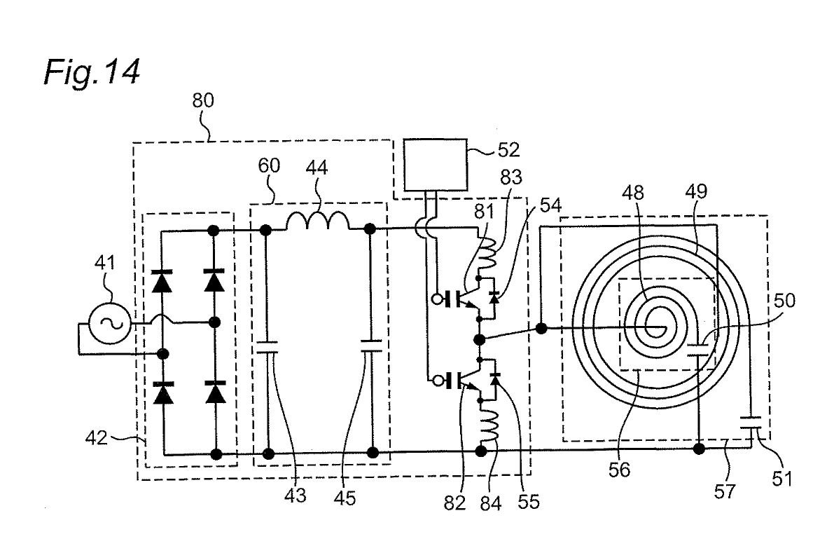

FIG. 12 is a plan view of the heating coils in the induction heating apparatus in the induction heating cooker according to the seventh embodiment. As illustrated in FIG. 12, in the induction heating cooker according to the seventh embodiment, the two heating coils 70 and 71 are placed just beneath a single heating area 72 formed on a top plate, and the two heating coils 70 and 71 juxtaposed to each other are adapted to inductively heat an object to be heated. Accordingly, the induction heating cooker according to the seventh embodiment is structured such that the plurality of heating coils 70 and 71 are juxtaposed to each other, rather than being structured such that a plurality of heating coils are placed concentrically just beneath a single heating area, as the structures illustrated in the aforementioned first to sixth embodiments.

There will be described operations in the induction heating cooker having the aforementioned structure according to the seventh embodiment.

As illustrated in the plan view of FIG. 12, just beneath the heating area 72 in which an object to be heated is to be placed, the first heating coil 70 and the second heating coil 71 are juxtaposed to each other in substantially the same plane, so that their induction heating surfaces are substantially flush with each other. By placing an object to be heated in this heating area 72, the object to be heated is heated by the two heating coils 70 and 71 substantially uniformly.

In the induction heating cooker according to the seventh embodiment, the two heating coils 70 and 71 are formed, such that they are individually wound and, further, are juxtaposed to each other. The two heating coils 70 and 71 are placed, such that they face the heating area 72 and form the same planar surface. Since the object to be heated is placed on the heating area 72, the object to be heated certainly exists above at least a single heating coil, out of the two heating coils 70 and 71. Therefore, the object to be heated placed on the heating area 72 is certainly and sufficiently subjected to induction heating by the heating coils 70 and 71.

In the induction heating cooker according to the seventh embodiment, when a pan 73 as an object to be heated, for example, is placed in a state where it is deviated from the center of the heating area 72 (in a state where the pan bottom of the pan 73 is placed as indicated by a broken line in FIG. 12), the pan 73 is placed above the first heating coil 70. This causes the first heating coil 70 to be magnetically coupled to the pan 73, which heightens the resonance frequency of the first resonant circuit 56 including the first heating coil 70.

On the other hand, the pan 73 is not placed above the second heating coil 71 and, therefore, the second resonant circuit 57 including the second heating coil 71 has a lower resonance frequency.

In the induction heating cooker according to the seventh embodiment, the resonance frequency of the first resonant circuit 56 including the first heating coil 70 above which the pan 73 is placed (see the resonance frequency f1 in the waveform W1 in FIG. 4 described above) is higher than the resonance frequency of the second resonant circuit 57 including the second heating coil 71 above which the pan 73 is not placed (see the resonance frequency f5 in the waveform W5 in FIG. 4 described above). Further, in the induction heating cooker according to the seventh embodiment, the operating frequency of the inverter circuit 40 is set to fall within a frequency range which is higher than the resonance frequency of the first resonant circuit 56 including the first heating coil 70 above which the pan 73 is placed. Namely, in the induction heating cooker according to the seventh embodiment, electric power is supplied, in a usual manner, to the pan 73 from the first heating coil 70 above which the pan 73 exists, while reduced electric power is supplied to the pan 73 from the second heating coil 71 above which the pan 73 is not placed, similarly to in the control operations (see FIG. 4) described with respect to the induction heating cooker according to the aforementioned second embodiment.

As described above, in the induction heating cooker according to the seventh embodiment, it is possible to reduce the electric current flowed through the second heating coil 71, thereby reducing the loss induced by the electric current flowed through the second heating coil 71. Further, it is possible to reduce the leaked magnetic field from the second heating coil 71.

Further, in the induction heating cooker according to the seventh embodiment, the plurality of heating coils are juxtaposed to each other, rather than being structured concentrically. Therefore, it is desirable that the resonance frequencies of the respective resonant circuits including the heating coils are made substantially coincident with each other, in a state where an object to be heated is placed above the respective heating coils.

By making the resonance frequencies of the respective resonant circuits substantially coincident with each other, it is possible to cause the resonance frequency of the second resonant circuit 57 including the second heating coil 71 to be higher than the resonance frequency of the first resonant circuit 56 including the first heating coil 70, for example, when the pan 73 is deviated in the opposite direction from that of the placement of the pan 73 illustrated in FIG. 12, such as when the pan 73 exists above the second heating coil 71 but the pan 73 does not exist above the first heating coil 70.

Accordingly, by setting the operating frequency of the inverter circuit 40 such that it falls within a frequency range which is higher than the resonance frequency of the second resonant circuit 57 including the second heating coil 71 above which the pan 73 is placed, it is possible to supply electric power to the pan 73 from the second heating coil 71 and, further, it is possible to flow a reduced electric current through the first heating coil 70, thereby reducing the loss induced by the electric current flowed through the first heating coil 70.

Further, since the electric current flowed through the first heating coil 70 can be suppressed as described above, it is possible to reduce the leaked magnetic field from the first heating coil 70. Namely, in order to reverse the relation between the resonance frequencies according to the presence or absence of magnetic coupling to the pan 73 as the object to be heated, it is necessary that the plurality of resonant circuits are in a state where their resonance frequencies are close to each other.

In this case, in order to make the resonance frequencies of the plurality of resonant circuits substantially coincident with each other, it is possible to most simply structure them, by connecting a plurality of heating coils with substantially the same shape to capacitors having substantially the same capacitance. Further, in cases where the respective heating coils have different inductances and the like since the plurality of heating coils have different shapes, it is also possible to connect, thereto, capacitors having capacitances based on these inductances, in order to make the resonance frequencies substantially coincident with each other.

Further, in the induction heating cooker according to the seventh embodiment, for example, in the case of the structure of the heating coils illustrated in FIG. 12, it is preferable to connect the respective heating coils 70 and 71 such that an electric current flows through the second heating coil 71 in the counterclockwise direction while an electric current flows through the first heating coil 70 in the clockwise direction. By connecting the heating coils 70 and 71 as described above, when the pan 73 as the object to be heated is placed such that it straddles the two heating coils 70 and 71 and, thus, the pan 73 does not exist above portions of the respective heating coils 70 and 71, a leaked magnetic field generated from the portion of the first heating coil 70 above which the pan 73 is not placed and a leaked magnetic field generated from the portion of the second heating coil 71 above which the pan 73 is not placed are cancelled by each other, thereby reducing the leaked magnetic fields.

Next, there will be described the fact that the induction heating cooker according to the seventh embodiment is controlled according to different methods depending on the condition of usage thereof.

Different usage states which will be described hereinafter refer to states where a pan as an object to be heated is placed such that it is overlaid on the heating area above all the heating coils 70 and 71 and, inside the pan, the contents thereof are placed biasedly therein.

FIG. 13 is a plan view illustrating the relation in placement among the two heating coils 70 and 71, the pan 73 as the object to be heated, the content 74 inside the pan 73, during a heating operation in the induction heating cooker according to the seventh embodiment. In the heating operation illustrated in FIG. 13, the content 74 having a larger capacity is biasedly placed within the pan 73.

Hereinafter, there will be described control operations in the induction heating cooker according to the seventh embodiment, in a state where the heating coils 70 and 71, the pan 73 and the content 74 as objects to be heated are placed as illustrated in FIG. 13.

As illustrated in FIG. 13, the pan 73 as the object to be heated is placed such that it is substantially overlaid on an area above the first heating coil 70 and the second heating coil 71, and an ingredient (for example, a steak) as the content 74 is baked by being placed above only the first heating coil 70.

In the heating state illustrated in FIG. 13, when the pan 73 has a poor heat transfer characteristic, the temperature at the area above the second heating coil 71 where the content 74 is not placed is higher than the temperature at the area above the first heating coil 70 where the content 74 is placed, since the ingredient 74 removes heat therefrom. When the temperature of the pan 73 has been raised, the metal forming the pan has an increased electrical resistance, which reduces the electric power supplied to the pan 73.

Accordingly, in the induction heating cooker according to the seventh embodiment, when the pan is at a predetermined temperature, the electric power supplied to the pan 73 from the first heating coil 70 and the electric power supplied to the pan 73 from the second heating coil 71 are set to be substantially equal to each other. Due to such a setting, with the induction heating cooker according to the seventh embodiment, in the event of unevenness of the temperature of the pan 73, since the content 74 is biasedly placed within the pan 73, the electric power supplied to the pan 73 from the heating coil placed below the area of the pan 73 being at a higher temperature (the second heating coil 71, in FIG. 13) is made smaller than the electric power supplied to the pan 73 from the heating coil placed below the area of the pan 73 which is being at a lower temperature since the content 74 is placed therein (the first heating coil 70, in FIG. 13).

Due to the aforementioned setting, with the induction heating cooker according to the seventh embodiment, even in a state where the content 74 is biasedly placed within the pan 73 as the object to be heated, it is possible to substantially uniformize the temperature of the pan 73, which enables cooking the content (ingredient) 74 without inducing baking unevenness.

The heating operations illustrated in FIG. 13 have been described with respect to a case where the content 74 is a lump of steak meat as an ingredient and, therefore, the content 74 has a larger capacity with a substantially constant thickness, which makes it clear whether or not the content 74 exists in the pan. However, the structure of the induction heating cooker according to the seventh embodiment is also effective, in cases where the object to be heated is a content 74 having various thicknesses at different positions thereof, such as fish, for example. The pan 73 tends to be reduced in temperature at its portion carrying a portion of such a content 74 which has a larger thickness and, therefore, it is possible to supply larger electric power to the heating coil below the portion thereof having the larger thickness while supplying smaller electric power to the heating coil below the portion thereof having a smaller thickness. For objects to be heated including such a content 74 having various thicknesses at different positions therein, it is possible to employ two or more sets of heating coils for a single heating area, which can further equalize the temperatures at respective portions in the heating area. Accordingly, with the structure according to the seventh embodiment, it is possible to provide an induction heating cooker having significantly-improved cooking performance.

While there is illustrated, in FIG. 12 and FIG. 13, a structure including two heating coils with an elliptical shape which are juxtaposed to each other in a single heating area, the induction heating apparatus according to the present invention is not limited to this structure. The structure according to the seventh embodiment of the present invention is adapted to utilize the fact that the resonant circuits exhibit different characteristics depending on whether or not an object to be heated is placed above the heating coils. Therefore, in the induction heating apparatus according to the present invention, the planar shapes of the heating coils are not limited to the shapes of the heating coils according to the seventh embodiment, and they can have various shapes, such as circular shapes, rectangular shapes, triangular shapes. Further, in the induction heating apparatus according to the present invention, regarding the number of heating coils, three or more sets of heating coils can be employed for inductively heating an object to be heated placed in a single heating area.

### Eighth Embodiment

Hereinafter, an induction heating cooker according to an eighth embodiment of the present invention will be described. FIG. 14 is a circuit diagram illustrating the structure of an inverter circuit and the like, in an induction heating apparatus, in the induction heating cooker according to the eighth embodiment. In FIG. 14, the components having substantially the same functions and the same structures as those of the induction heating cooker according to the aforementioned first embodiment illustrated in FIG. 1 will be designated by the same reference characters.

As illustrated in FIG. 14, in the induction heating cooker according to the eighth embodiment, the inverter circuit 80 is structured to include a diode bridge 42 connected to a commercial power supply 41, a filter circuit 60, and two switching devices 81 and 82, and, further, a control portion 52 is adapted to drive and control the switching devices 81 and 82, similarly to in the induction heating cooker according to the aforementioned first embodiment. Further, in the inverter circuit 80 according to the eighth embodiment, coils 83 and 84 as inductors are connected, in series, to the two switching devices 81 and 82. As described above, in the structure of the inverter circuit 80 according to the eighth embodiment, the coils 83 and 84 are connected, in series, to the switching devices 81 and 82. Therefore, the inverter circuit 80 are structured to perform switching operations (in ON states) such that the phase of the electric current leads the phase of the voltage, thereby performing soft switching operations which induce reduced losses in the switching devices 81 and 82.

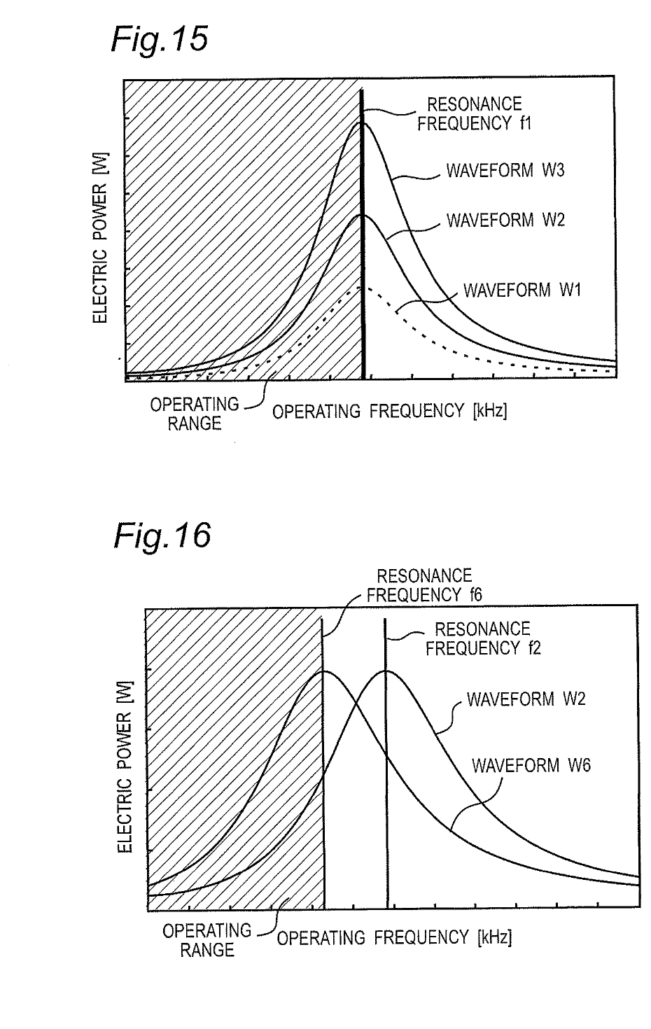

FIG. 15 is a frequency-characteristics diagram indicating the relation between the operating frequency of the inverter circuit 80 and the maximum electric powers which can be inputted to heating coils 48 and 49, in the induction heating apparatus in the induction heating cooker according to the eighth embodiment. In FIG. 15, the lateral axis represents the operating frequency [kHz], and the longitudinal axis represents the maximum electric power [W] which can be inputted to the heating coils 48 and 49. Referring to FIG. 15, a waveform W1 represents the relation between the operating frequency of the inverter circuit 80 and the maximum electric power which can be inputted to the first heating coil 48, while a waveform W2 represents the relation between the operating frequency and the maximum electric power which can be inputted to the second heating coil 49. Further, a waveform W3 represents the relation between the operating frequency and the value of the sum of the maximum electric power which can be inputted to the first heating coil 48 and the maximum electric power which can be inputted to the second heating coil 49. The waveform W1 and the waveform W2 indicate frequency characteristics of when an object to be heated is placed in the heating area on the top plate, indicating frequency characteristics in a state where the object to be heated exists above both the first heating coil 48 and the second heating coil 49. In the induction heating cooker according to the eighth embodiment, the resonance frequencies (f1) in the waveform W1 and the waveform W2 are equal to each other.

Further, the induction heating cooker according to the eighth embodiment employs the inverter circuit 80 which is structured to perform switching operations (in ON states) in such a way that the phase of the electric current leads the phase of the voltage, for causing the switching devices 81 and 82 to perform soft switching operations, as illustrated in the circuit diagram in FIG. 14.

Further, the induction heating cooker according to the eighth embodiment is not structured to lower the resonance frequencies for reducing the electric currents supplied to the heating coils, if the heating coils are not magnetically coupled to the object to be heated, as described in the aforementioned first to seventh embodiments. Therefore, with the induction heating cooker according to the eighth embodiment, it is impossible to offer the effects described in the aforementioned first to seventh embodiments, which can be offered under conditions where there is no magnetic coupling between the heating coils and the object to be heated.

As indicated as an operating range in the frequency-characteristics diagram in FIG. 15, the induction heating cooker according to the eighth embodiment utilizes, as the operating range, a frequency range which is lower than the resonance frequency (the resonance frequency f1 in the waveform W1) of the first resonant circuit 56 including the first heating coil 48 and than the resonance frequency (the resonance frequency f1 in the waveform W2) of the second resonant circuit 57 including the second heating coil 49.

Next, there will be described the induction heating cooker having the aforementioned structure and having the frequency characteristics illustrated in FIG. 15, according to the eighth embodiment.

In the induction heating cooker according to the eighth embodiment, the operating frequency of the inverter circuit 80 is set to fall within a frequency range (an operating range) which is lower than the lower resonance frequency, out of the resonance frequency of the first resonant circuit 56 including the first heating coil 48 and the resonance frequency of the second resonant circuit 57 including the second heating coil 49. Further, as illustrated in FIG. 15, in the induction heating cooker according to the eighth embodiment, the first resonant circuit 56 and the second resonant circuit 57 have the same resonance frequencies (f1), but if they have different resonance frequencies, the operating range is set to be a frequency range lower than the lower resonance frequency out of them. Since the operating frequency of the inverter circuit 80 is set to fall within the operating range illustrated by hatching in the frequency characteristics diagram illustrated in FIG. 15, for example, as described above, if the operating frequency of the inverter circuit 80 is increased within this operating range, the electric powers inputted to the two heating coils 48 and 49 are both increased.

Accordingly, if the operating frequency of the inverter circuit 80 is increased within this operating range, the value of the sum of the electric powers inputted to the two heating coils 48 and 49 is certainly increased. As described above, with the induction heating cooker according to the eighth embodiment, by changing the operating frequency of the inverter circuit 80, it is possible to easily and certainly adjust the electric power supplied to the object to be heated.

In the induction heating cooker, it is necessary that the relation between the input electric currents and the operating frequency of the inverter circuit 80 has been grasped in advance, with high accuracy, when it is necessary to heat objects to be heated such as pans of various types with constant electric power, such as when it is necessary to detect whether or not an object to be heated such as a pan is being placed above the heating coils based on the relation between the input electric currents and the operating frequency, when it is necessary to determine as to which material forms the object to be heated placed thereon based on the relation between the input electric currents and the operating frequency, and when it is necessary to select an operating frequency suitable for load characteristics of objects to be heated.

In the induction heating cooker according to the eighth embodiment, the change of the electric power with respect to the change of the operating frequency of the inverter circuit 80 is caused to appear as simple increases and decreases, which enables stably and reliably adjusting the operating frequency for coping with load fluctuations and changes of electric power settings. Accordingly, by applying the structure according to the eighth embodiment to an induction heating cooker to be subjected to severe load fluctuations, it is possible to provide an induction heating cooker with excellent reliability.

Further, in the induction heating cooker according to the eighth embodiment, even though the electric currents flowed through the two heating coils 48 and 49 are controlled, the number of the switching devices 81 and 82 in the inverter circuit 80 is two and, thus, is not different from the number of switching devices in a conventional inverter circuit, which enables fabrication of the inverter circuit 80 with lower costs, thereby providing an inexpensive cooking device.

### Ninth Embodiment

Hereinafter, an induction heating cooker according to a ninth embodiment of the present invention will be described.

The induction heating cooker according to the ninth embodiment has the same structure as that of the induction heating cooker according to the aforementioned eighth embodiment and is structured to include an inverter circuit 80 which is adapted to perform switching operations (in ON states) such that the phase of the electric current leads the phase of the voltage, thereby performing soft switching operations, as illustrated in FIG. 14. Accordingly, in the induction heating cooker according to the ninth embodiment, the components having substantially the same functions and the same structures as those of the induction heating cooker according to the eighth embodiment will be designated by the same reference characters and will not be described herein. The induction heating cooker according to the ninth embodiment has a structure similar to that of the induction heating cooker according to the aforementioned first embodiment illustrated in FIG. 1.

FIG. 16 is a frequency-characteristics diagram indicating the relation between the operating frequency of the inverter circuit 80 and the maximum electric powers which can be inputted to respective heating coils 48 and 49, in the induction heating cooker according to the ninth embodiment. In FIG. 16, the lateral axis represents the operating frequency [kHz], and the longitudinal axis represents the maximum electric power [W] which can be inputted to the heating coils 48 and 49.

FIG. 16 illustrates frequency characteristics of when there is placed, in a heating area above the second heating coil 49, an object to be heated (a pan) which has a diameter larger than the diameter of the second heating coil 49 outside the first heating coil 48. Referring to FIG. 16, a waveform W2 indicates a frequency characteristic in a state where the object to be heated exists above the second heating coil 49, and a waveform W6 indicates a frequency characteristic in a state where the object to be heated exists above the first heating coil 48, similarly to the aforementioned frequency characteristics illustrated in FIG. 5 (the third embodiment).

In the induction heating cooker according to the ninth embodiment, as illustrated in FIG. 16, the resonance frequency f6 (the waveform W6) of the first resonant circuit 56 including the first heating coil 48 and the resonance frequency 12 (the waveform W2) of the second resonant circuit 57 including the second heating coil 49 have different values.

Further, in the induction heating cooker according to the ninth embodiment, the coils 83 and 84 are connected, in series, to the switching devices 81 and 82. Therefore, the inverter circuit 80 are structured to perform switching operations (in ON states) such that the phase of the electric current leads the phase of the voltage to perform soft switching operations which induce less losses in the switching devices 81 and 82.

Further, in the induction heating cooker according to the ninth embodiment, even if a heating coil is not magnetically coupled to the object to be heated, it is impossible to offer the effect of lowering the resonance frequency for reducing the electric current supplied to this heating coil, similarly to in the induction heating cooker according to the aforementioned eighth embodiment. Therefore, with the induction heating cooker according to the ninth embodiment, it is impossible to offer the effects described in the aforementioned first to seventh embodiments, which can be offered under conditions where there is no magnetic coupling between the heating coils and the object to be heated.

As illustrated in the frequency-characteristics diagram illustrated in FIG. 16, the induction heating cooker according to the ninth embodiment is different from the induction heating cooker according to the aforementioned eighth embodiment, in that, when there is placed an object to be heated having a diameter larger than that of the second heating coil 49, the resonance frequency (f6) of the first resonant circuit 56 including the first heating coil 48 and the resonance frequency (f2) of the second resonant circuit 57 including the second heating coil 49 have different values.

Next, there will be described operations of the induction heating cooker having the frequency characteristics illustrated in FIG. 16, according to the ninth embodiment.

As described above, referring to FIG. 16, there is illustrated the operating frequency of the inverter circuit 80, when the resonance frequency f6 (waveform W6) of the first resonant circuit 56 including the first heating coil 48 and the resonance frequency f2 (waveform W2) of the second resonant circuit 57 including the second heating coil 49 have different values.

The induction heating cooker according to the ninth embodiment utilizes a frequency range lower than the lowest resonance frequency (f6 in FIG. 16) out of the two resonance frequencies (f2, f6), as an operating frequency for the inverter circuit 80, so that the change of the electric power appears as simple increases and decreases with respect to the change of the operating frequency of the inverter circuit 80 in the operating range. As a result thereof, with the induction heating cooker according to the ninth embodiment, it is possible to stably and reliably change the operating frequency, for coping with load fluctuations and changes of electric power settings. Further, with the induction heating cooker according to the ninth embodiment, it is possible to easily and accurately change the ratio of the electric powers which can be inputted to the plurality of heating coils, without necessitating fabrication of the plurality of heating coils such that their characteristics match each other.

The aforementioned first to sixth embodiments, the aforementioned eighth and ninth embodiments have been described as having structures employing a combination of two sets of heating coils constituted by a heating coil with a smaller diameter and a heating coil with a larger diameter. Further, the induction heating cooker according to the seventh embodiment has been described as having a structure employing two sets of heating coils having the same shape which are juxtaposed to each other. However, the induction heating apparatus according to the present invention is not limited to these structures of heating coils.

In the induction heating apparatus according to the present invention, the number of heating coils in a single heating area is not limited to two, as described above, and the induction heating apparatus according to the present invention also includes structures which form a single heating area with a plurality of heating coils. For example, a single heating area can be formed using three or four heating coils having a circular shape with a smaller diameter. Also, a single heating area can be formed using three heating coils which are constituted by a heating coil with a smaller diameter, a heating coil with a medium diameter, and a heating coil with a larger diameter. With this structure, the induction heating apparatus according to the present invention is enabled to control the electric currents flowed through the respective heating coils according to the areas of the heating coils and the numbers of windings therein, which enables accurately coping with load fluctuations for realizing higher reliability, reducing the manufacturing cost, and improving the safety, as effects of the present invention.

Further, in the induction heating cookers according to the aforementioned first to ninth embodiments, provided that the switching devices 46, 47, 81 and 82 employed in the inverter circuits 40 and 80 meet high-level specifications which induce extremely-smaller switching losses which do not largely influence the heating efficiency, it is possible to employ a circuit structure which does not connect, thereto, the snubber capacitor 53 and the coils 83 and 84, which can form an inexpensive induction heating cooker having a smaller number of components. In addition thereto, such an inverter circuit structure which does not connect, thereto, the snubber capacitor 53 and the coils 83 and 84 can reduce switching losses, in cases where the switching devices are controlled and driven in such a way as to employ, as operating ranges for the same inverter circuit, both frequency ranges which are higher and lower than the highest and lowest resonance frequencies, out of the respective resonance frequencies of the plurality of resonant circuits, for example, according to heating conditions.

Further, while the aforementioned first to ninth embodiments have been described by exemplifying induction heating cookers, the present invention is not limited to induction heating cookers and can be applied to any devices adapted to perform heating by utilizing the principle of induction heating.

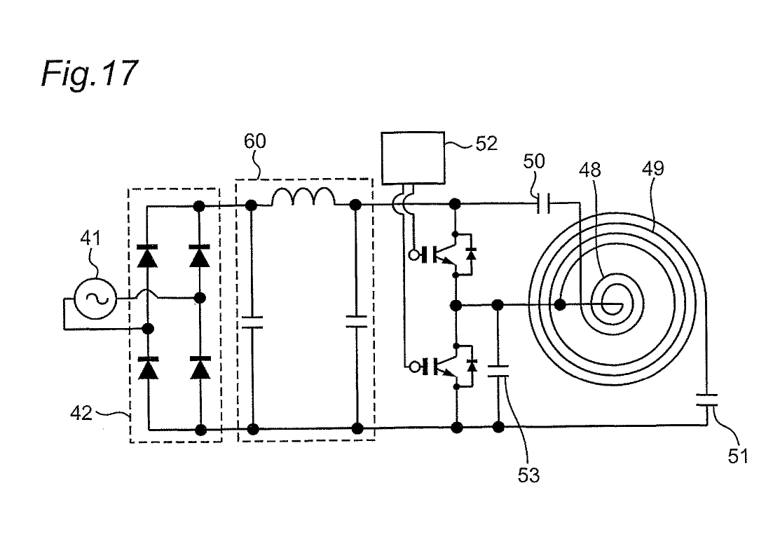

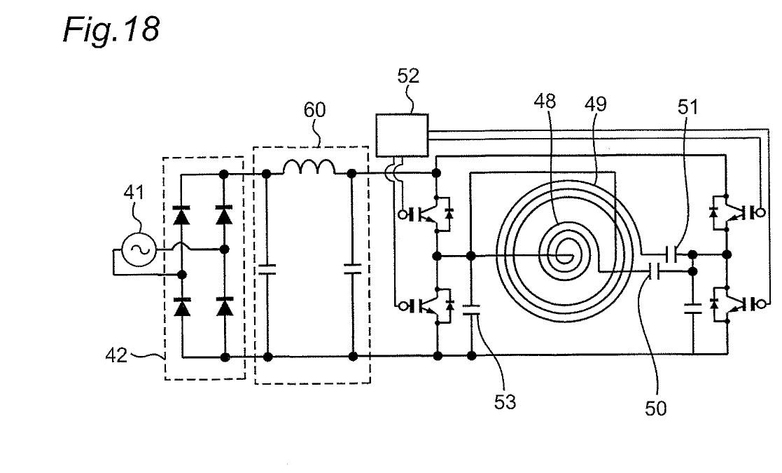

Further, while the inverter circuits described in the aforementioned first to ninth embodiments have been described as having structures which connect the two switching devices to each other in series and, further, connect the resonant circuits between the negative bus line and the point of the connection between these two switching devices, which is called a SEPP circuit (Single End Push Pull circuit), the present invention is not limited to these structures. For example, the inverter circuit can have a structure which connects one of the resonant circuits to the positive bus line as illustrated in FIG. 17 or can have a full-bridge circuit structure as illustrated in FIG. 18, which can also offer the effects of the induction heating apparatus according to the present invention. FIG. 17 and FIG. 18 illustrate circuit structures in the induction heating apparatus and the like according to the present invention, particularly illustrating the circuit structures of inverter circuits.

As described above, the induction heating apparatus according to the present invention is structured to heat a single to-be-heated object using the plurality of heating coils, wherein different electric currents can be flowed through the respective heating coils at the same time, even though the common inverter circuit is used for the respective heating coils. Accordingly, with the induction heating apparatus according to the present invention, it is possible to adjust the balance between heating electric powers for performing uniform heating and, further, it is possible to largely reduce the manufacturing cost.

Further, the induction heating apparatus according to the present invention is structured to be capable of maintaining predetermined electric power, even when reduced electric currents are flowed through the heating coils. This can suppress self-heat generation from the coil wires in the heating coils, thereby largely improving the heating efficiency.

Further, the induction heating apparatus according to the present invention is capable of certainly and accurately controlling the electric power and, also, is capable of suppressing losses in the switching devices even in the event of load fluctuations, although it is structured to operate the plurality of heating coils through the single inverter circuit.

### INDUSTRIAL APPLICABILITY

The induction heating apparatus according to the present invention is capable of efficiently and uniformly heating objects to be heated and, therefore, can be applied to various types of heating apparatuses which utilize induction heating.

### REFERENCE SIGNS LIST

40 Inverter circuit

41 Commercial power supply

42 Diode bridge

43, 45 Filter capacitor

44 Filter inductor

46 First switching device

47 Second switching device

48 First heating coil

49 Second heating coil

50 First resonant capacitor

51 Second resonant capacitor

52 Control portion

53 Snubber capacitor

56 First resonant circuit

57 Second resonant circuit

60 Filter circuit

1. An induction heating apparatus comprising:
an inverter circuit which includes two switching devices connected in series and outputs an AC signal by driving the two switching devices;
a control portion which drives and controls the two switching devices; and
a plurality of resonant circuits each of which includes a respective resonant capacitor and a respective heating coil and connects to a connecting point between the two switching devices so as to supply constantly the AC signal from the inverter circuit to the plurality of heating coils,
wherein
the control portion drives and controls the plurality of switching devices, by using, as an operating range, a frequency range higher than a highest resonance frequency, or a frequency range lower than lowest resonance frequency, out of respective resonance frequencies of the plurality of resonant circuits, and
the respective heating coils in the plurality of resonant circuits are combined to form at least a single induction heating source, whereby an object to be heated is inductively heated by the at least a single induction heating source.

2. The induction heating apparatus according to claim 1, wherein
the heating coils and the resonant capacitors in the plurality of resonant circuits are configured to have inductances and capacitances, respectively, which are set, such that the object to be heated is inductively heated by all the heating coils forming the single induction heating source, in the operating range of the switching devices.

3. The induction heating apparatus according to claim 1, wherein
the control portion is configured to drive and control the switching devices, by using, as an operating range, only a frequency range higher than the highest resonance frequency, out of the respective resonance frequencies of the plurality of resonant circuits.

4. The induction heating apparatus according to claim 3, wherein
a snubber circuit is connected, in parallel, to the resonant circuits.

5. The induction heating apparatus according to claim 1, wherein
the control portion is configured to drive and control the switching devices, by using, as an operating range, only a frequency range lower than the lowest resonance frequency, out of the respective resonance frequencies of the plurality of resonant circuits.

6. The induction heating apparatus according to claim 5, wherein
an inductor is connected, in series, to the two switching devices, whereby the plurality of switching devices are caused to perform a soft switching operation such that a phase of an electric current leads a phase of a voltage.

7. The induction heating apparatus according to claim 1, wherein
the respective resonance frequencies of the plurality of resonant circuits are set to have different values, with the inductances of the heating coils and the capacitances of the resonant capacitors.

8. The induction heating apparatus according to claim 7, wherein
in the plurality of resonant circuits, the resonance frequency of the resonant circuit including the heating coil to which larger electric power is inputted is set to be higher than the resonance frequency of the resonant circuit including the heating coil to which smaller electric power is inputted.

9. The induction heating apparatus according to claim 1, wherein
the ratio between electric powers inputted to the plurality of heating coils forming a single induction heating source is a ratio coincident with respective areas of the plurality of heating coils which are faced to the object to be heated.

10. The induction heating apparatus according to claim 1, wherein
the ratio between the values of electric currents flowed through the plurality of heating coils forming a single induction heating source is a ratio coincident with cross-sectional areas of respective coil wires forming the plurality of heating coils which are orthogonal to a direction in which an electric current flows through the coil wires.

11. The induction heating apparatus according to claim 1, wherein
the plurality of heating coils forming a single induction heating source are placed in the same plane.

12. The induction heating apparatus according to claim 3, wherein
the plurality of heating coils forming a single induction heating source are placed concentrically and are formed to have respective coil shapes having different diameters.

13. An induction heating cooker comprising:
a top plate for placing an object to be heated thereon; and
the induction heating apparatus according to claim 1, wherein a plurality of heating coils as an induction heating source are placed under the top plate.

14. The induction heating cooker according to claim 13, wherein
the top plate has a plurality of heating areas for placing the object to be heated therein, and
the induction heating apparatus is provided as an induction heating source for at least a single heating area, out of the plurality of heating areas.
